(19) United States
(12) Patent Application Publication
(10) Pub. No.: US 2002/0156731 A1
(43) Pub. Date: Oct. 24, 2002

(54) System and method for supporting delivery of services

(75) Inventors: Junji Seki, Kawasaki (JP); Yasuhisa Yoshida, Tokyo (JP); Isao Tsumita, Tokyo (JP); Akihiko Marumoto, Tokyo (JP); Junichi Mizuno, Tokyo (JP)

Correspondence Address: STAAS & HALSEY LLP, 700 11TH STREET, NW, SUITE 500, WASHINGTON, DC, 20001, US

(73) Assignee: Fujitsu Limited of Kawasaki, Japan

(21) Appl. No.: 09/928,354

(22) Filed: Aug. 14, 2001

(30) Foreign Application Priority Data
Apr. 19, 2001 (JP) 2001-121680

(51) Int. Cl. G06F 17/60

(52) U.S. Cl. 705/40; 705/4; 705/5; 705/26

(57) ABSTRACT

A method of assisting delivery of useful services that contribute to improvement of people's standard of living. The method starts with providing, via a network, information about paid services to a customer who has signed up for membership with payment of a predetermined fee. A purchase order for one of the paid services is received from the terminal of the customer which is connected to the service delivery support system via the network. The customer's creditworthiness is evaluated, based on the amount of the predetermined fee that has been paid by the customer, thus determining how much on-behalf payment can be offered to the customer in payment for the paid service that the customer has ordered. The customer is notified of the determined amount of on-behalf payment.

### BACKGROUND OF THE INVENTION

1. Field of the Invention

The present invention relates to a service delivery supporting method and a service ordering method, as well as to a service delivery support system and a terminal used therefor, which support a process of ordering and providing personal service products, such as insurance and travel packages. More particularly, the present invention relates to a service delivery support method, a service ordering method, and a service delivery support system and a terminal used therefor, which facilitate the provision of paid services.

2. Description of the Related Art

A wide variety of insurance products are currently on the market to protect against financial risks that individuals may face. Many insurance companies provide the purchasers of their products with various extra benefits, including:

financing services

counseling services for pension planning, medical care, insurance strategies, and so on

referral to care providers, hospitals, and specialist physicians

appointment-based home care services

Insurance buyers are entitled to enjoy those financial and health care services.

Such financial services offered at present, however, have not gained wide acceptance because of their lack of accessibility and usability. More specifically, they have the following drawbacks:

While insurance purchasers are eligible for financial aid from insurance companies, the process of application and approval is not convenient enough for them to use such services readily.

Conventionally, the insurance holders' benefits other than financial ones are confined to health-related services, such as medical counseling and home care consultation, which are targeted to those who have concerns about their physical conditions. In other words, there have been few services beneficial to healthy people.

Not a few people have an uncertain feeling about their future, which prevents them from spending their money for what they can actually afford. It is therefore needed to provide such financial support services that will encourage people to spend their money for their own purposes while alleviating their concerns about future financial risks.

It is a natural desire for people to find their lives worth living. For this reason, many retired elderly people wish to work (but not to be tied to the work), taking advantage of their former experiences. Working as a contract worker for insurance sales would be one of the possibilities for such people, and assisting customers to acquire an agent license would not only be a great help for them, but also give a business chance to insurance companies. Conventional insurance providers, however, have not contributed to serving this need for job opportunities.

Some people may have an ability to produce new service products, based on their experiences in the fields. Actually, however, there have been few opportunities for such people to demonstrate their product planning capabilities.

Different types of services are available from different providers, meaning that there are as many customer support contacts as the number of service providers. This situation is inconvenient to customers since they have to ask questions, if any, at different places.

Insurance customers find it difficult to manage by themselves the services that they are using.

Insurance providers have been failing to support their customers with a unified management tool or one-stop service management facilities.

As seen from the above, conventional bonus features offered to insurance purchasers are mere financial or health-care services, which give little contribution to addressing the real needs of customers who wish to enjoy their lives without having to worry about the future.

### SUMMARY OF THE INVENTION

In view of the foregoing, it is an object of the present invention to provide a service delivery supporting method which assists delivery of useful services that contribute to improvement of people's standard of living. Another object of the present invention is to provide a service ordering method to achieve the same. Yet another object of the present invention to provide a service delivery support system for the same. Still another object of the present invention is to provide a client terminal for use with the service delivery support system.

To accomplish the first object, according to the present invention, there is provided a method executed by a computer to support service site operations for offering paid services to customers. This service delivery supporting method comprises the following steps: (a) providing, via a network, information about paid services to a customer who has signed up for membership with payment of a predetermined fee; (b) at a terminal of the customer which is connected to the computer via the network, receiving an order for one of the paid services; (c) evaluating creditworthiness of the customer, based on the amount of the predetermined fee that has been paid by the customer; (d) determining how much on-behalf payment can be offered to the customer in payment for the paid service that the customer has ordered; and (e) notifying the terminal of the determined amount of the on-behalf payment.

To accomplish the second object, according to the present invention, there is provided a method of ordering a service from a terminal to a service delivery support system. This service ordering method comprises the following steps: (a) displaying information about paid services obtained from the service delivery support system on a screen of the terminal; (b) sending a purchase order for one of the paid services to the service delivery support system in response to an input from a customer; (c) receiving information about on-behalf payment to be offered to the customer from the service delivery support system; and (d) displaying the amount of the on-behalf payment on the terminal.

To accomplish the third object, according to the present invention, there is provided a service delivery support system for supporting provision of paid services. This service delivery support system comprises the following elements: (a) an information providing unit which provides, via a network, information about paid services to a customer who has signed up for membership with payment of a predetermined fee; (b) a reception unit which receives an order for one of the paid services from a terminal of the customer which is connected to the service delivery support system via the network; (c) an on-behalf payment determining unit which evaluates creditworthiness of the customer, based on the amount of the predetermined fee that has been paid by the customer, and determines how much on-behalf payment can be offered to the customer in payment for the paid service that the customer has ordered; and (d) a notification unit which notifies the terminal of the determined amount of the on-behalf payment.

To accomplish the fourth object, according to the present invention, there is provided a terminal which sends a purchase order to a service delivery support system which assists delivery of paid services. This terminal comprises the following elements: (a) information displaying unit which displays information about paid services that is supplied from the service delivery support system; (b) an order sending unit which sends a purchase order for one of the paid services to the service delivery support system in response to an input from a customer; and (c) an on-behalf payment information displaying unit which receives information about on-behalf payment to be offered to the customer from the service delivery support system, and displays the amount of the on-behalf payment on the terminal.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 schematically shows a process of providing a paid service according to the present invention;

FIG. 2 schematically shows a process of supporting contract workers according to the present invention;

FIG. 3 schematically shows a process of supporting travel proposals according to the present invention;

FIG. 4 shows a system structure for assisting delivery of services according to the present invention;

FIG. 5 shows a typical hardware configuration of a service delivery support system according to the present invention;

FIG. 6 is a functional block diagram of a service delivery support system according to the present invention;

FIG. 7 shows resources constituting a membership database;

FIG. 8 shows a product information database record;

FIG. 9 shows a member profile database record;

FIG. 10 shows resources constituting a paid-service database;

FIG. 11 shows a travel package database record;

FIG. 12 shows a trade order database record;

FIG. 13 shows resources constituting a contract worker support database;

FIG. 14 shows a contract worker database record;

FIG. 15 shows resources constituting a license acquisition support database and a license support database record;

FIG. 16 shows resources constituting a travel proposal database;

FIG. 17 shows a proposal management database record;

FIG. 18 is a flowchart which shows the general process flow in the service delivery support system of the present invention;

FIG. 19 shows an example of transitions of pages which appear on a terminal;

FIG. 20 shows an example of a service site homepage;

FIG. 21 is a flowchart which shows the details of a membership registration routine;

FIG. 22 shows an example of a product information page;

FIG. 23 shows an example of a contract application page;

FIG. 24 shows an example of a registration result page;

FIG. 25 shows an example of a service menu page;

FIG. 26 is a flowchart of a paid service delivery routine;

FIG. 27 shows an example of a service product information page;

FIG. 28 shows an example of an order entry page;

FIG. 29 shows an example of an order confirmation page;

FIG. 30 shows an example of an order acknowledgement page;

FIGS. 31 and 32 are the first and second halves of a flowchart of a license acquisition support routine;

FIG. 33 shows an example of a license acquisition support menu page;

FIG. 34 shows an example of a business partnership registration page;

FIG. 35 shows an example of a license acquisition course application page;

FIG. 36 shows an example of an order confirmation page;

FIG. 37 shows an example of an order acknowledgement page;

FIG. 38 shows an example of a license data registration page;

FIG. 39 shows an example of a license registration confirmation page;

FIG. 40 shows an example of a license registration acknowledgment page;

FIG. 41 shows an example of a contract worker sign-up page;

FIG. 42 shows an example of a contract worker record confirmation page;

FIG. 43 shows an example of a contract worker sign-up acknowledgment page;

FIG. 44 is a flowchart of a contract worker support routine;

FIG. 45 shows an example of a contract worker menu page;

FIG. 46 shows an example of an insurance sales record entry page;

FIG. 47 shows an example of an insurance sales record confirmation page;

FIG. 48 shows an example of an insurance sales acknowledgment page;

FIG. 49 shows an example of an insurance sales status page;

FIG. 50 is a flowchart of a travel proposal support routine;

FIG. 51 shows an example of a planner invitation page;

FIG. 52 shows an example of a travel proposal entry page;

FIG. 53 shows an example of a travel proposal form;

FIG. 54 shows an example of a travel proposal confirmation page; and

FIG. 55 shows an example of a travel proposal acknowledgment page.

### DESCRIPTION OF THE PREFERRED EMBODIMENTS

Preferred embodiments of the present invention will be described below with reference to the accompanying drawings.

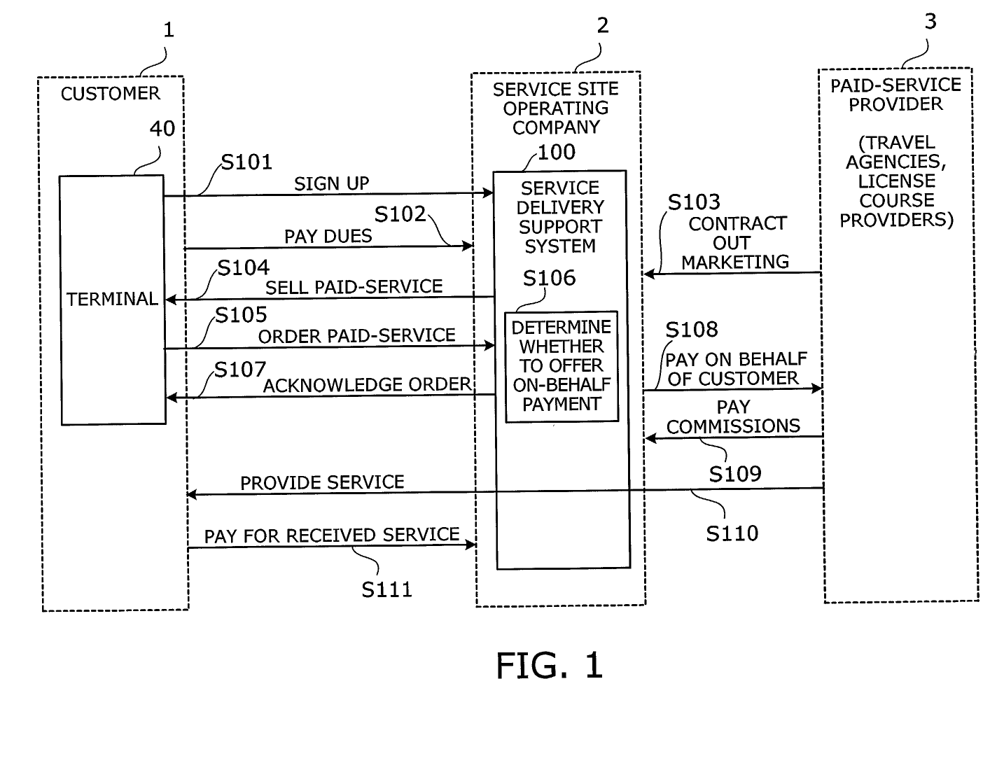

FIG. 1 schematically shows a process of providing a paid service according to the present invention. This process involves the following three entities: a customer 1 who will be a user of a paid service, a paid-service provider 3 which offers paid services, and a service site operating company 2 which mediates between the two parties 1 and 3. The customer interacts with the service site operating company 2, exchanging information and money. The paid-service provider 3 interacts with the service site operating company 2, contracting out the sales of their products and receiving payments. Through the mediation of the service site operating company 2, the service is delivered from the paid-service provider 3 to the customer 1. The service site operating company 2 employs a service delivery support system 100 to assist the customer 1. With his/her terminal 40, the customer 1 enjoys a variety of support functions that are available on the service delivery support system 100.

The service delivery process starts with an action of the customer 1 who makes access to the service delivery support system 100 in the service site operating company 2 through his/her terminal 40. Here, the customer 1 signs up for service membership (step S101), which is necessary for him/her to receive paid services. After the sign-up, the customer 1 pays membership dues to the service site operating company 2 (step S102). In one implementation, the paid service may be provided in association with particular insurance products. If this is the case, the step S101 is replaced with the customer's purchase order for an insurance policy, and the customer pays the insurance premium at step S102.

The paid-service provider 3, on the other hand, contracts out the marketing of their paid services to the service site operating company 2 (step S103). One example of such paid-service providers 3 is a travel agency which offers various tour package products, including hotel coupons, transportation tickets, and optional tour conducting services, based on pre-organized travel plans. Another example of paid-service providers 3 is a license school which provides license acquisition courses.

The service site operating company 2 sends paid-service information to the terminal 40 through the service delivery support system 100 in an attempt to sell the services to the customer 1 (step S104). The customer 1 browses the information on the terminal 40 and orders his/her desired service, if any. The purchase order is then transmitted from the terminal 40 to the service delivery support system 100 (step S105).

Upon receipt of the paid-service order, the service delivery support system 100 evaluates the customer's creditworthiness, based on the payment made at step S102. According to the result of this credit checking, the service delivery support system 100 determines the amount of the on-behalf payment that would be offered to assist his/her purchase (step S106), and it notifies the terminal 40 of the acknowledgment of the order (step S107). After that, the service site operating company 2 makes payment to the paid-service provider 3 (step S108) fully or partly for the ordered service on behalf of the customer 1, as determined at step S106. This payment step S108 may be executed automatically by the service delivery support system 100, without intervention of the service site operating company 2. More specifically, the service delivery support system 100 may be configured to log in to a server of a financial institution and request them to transfer a specified amount of money from the account of the service site operating company 2 to that of the paid-service provider 3.

Then the paid-service provider 3 pays predetermined commissions to the service site operating company 2 (step S109) and provides the customer 1 with the paid service that he/she has ordered (step S110). The customer 1 pays in turn the service dues to the service site operating company 2 within a predetermined period (step S111).

Through the above steps, the customer 1 enrolls himself/herself as a user of the service site by paying necessary membership dues, which entitles him/her to receive a paid service without having to worry about immediate payment of the service fee. The customer can enjoy paid services without hesitating, even in such cases where, for example, he/she does not have enough money at hand until the maturity of a time deposit. In this way, the present invention makes paid services more accessible to customers because of the relaxed time constraints.

As previously noted, it is possible to link the membership registration with a purchase of an insurance product. This means that insurance purchasers will be able to enrich their lives by enjoying the additional benefits (e.g., travels) offered by the insurance providers, besides ensuring their financial basis.

Orders for paid services are collected by the service delivery support system 100, regardless of what type of services they are. For example, a customer can apply for a tour package and a license course by sending the orders to the same place, although the two products are available from different providers. In this way, the present invention simplifies the ordering method by providing a unified sales window for different service products.

Further, the supported paid services includes license courses. Beside providing entertainment, the proposed system helps customers develop their careers.

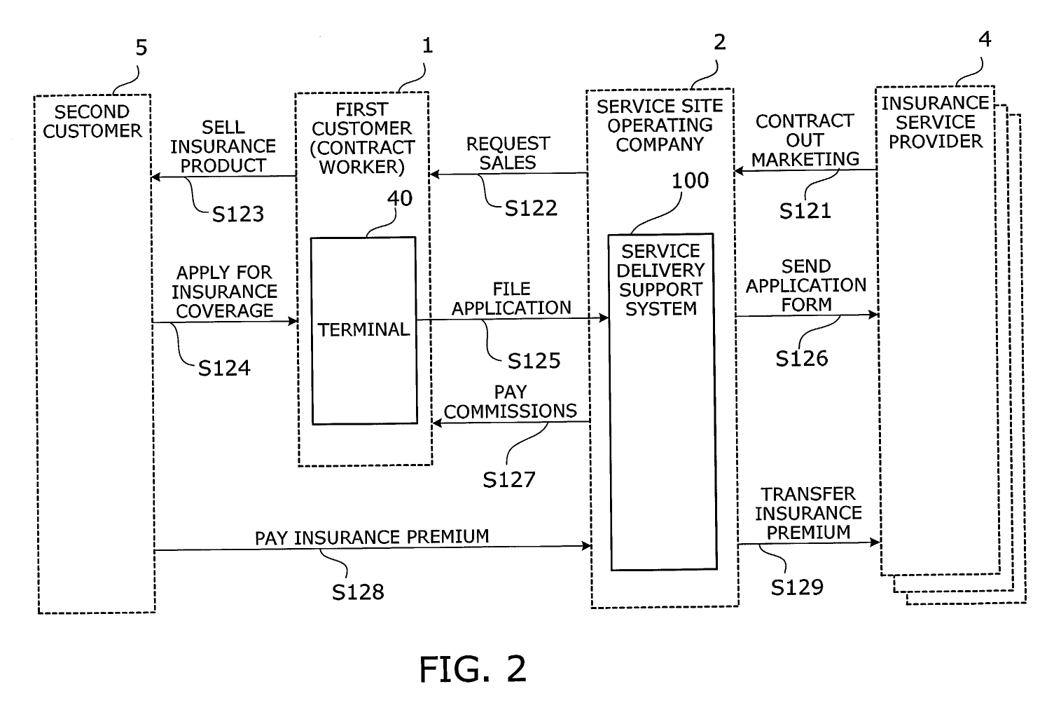

In the present embodiment of the invention, customers are invited to a contract worker program, in which a registered customer serves as an insurance sales agent who is to be rewarded with commissions. FIG. 2 schematically shows a process of supporting this contract worker program according to the present invention. The insurance service provider 4 contracts out the marketing of their insurance products to the service site operating company 2 (step S121). The service site operating company 2 requests a first customer 1 who signed up as a contract worker to sell insurance products (step S122). The first customer 1 attempts to sell an insurance product to a second customer 5 (step S123). When the second customer 5 agrees to buy a specific insurance product, the first customer 1 receives an application for that insurance policy (step S124). The first customer 1 then files the application with the service delivery support system 100 through his/her terminal 40 (step S125).

Upon receiving the application, the service site operating company 2 sends the application form containing the information about the customer 5 to the insurance service provider 4 (step S126), while paying a commission to the customer 1 (step S127). When the application is approved, the customer 5 sends money to the account of the service site operating company 2 to pay for the insurance that he/she purchased (step S128). Finally, the service site operating company 2 transfers the insurance premium to the insurance service provider 4.

The embodiment shown in FIG. 2 allows the first customer 1 to work as an insurance agent at convenient times, giving him/her an opportunity to earn some extra money to live a wealthier live. For those who have no such sales agent licenses, the proposed system provides license acquisition courses as one of its paid services, encouraging them to participate in the contract worker program.

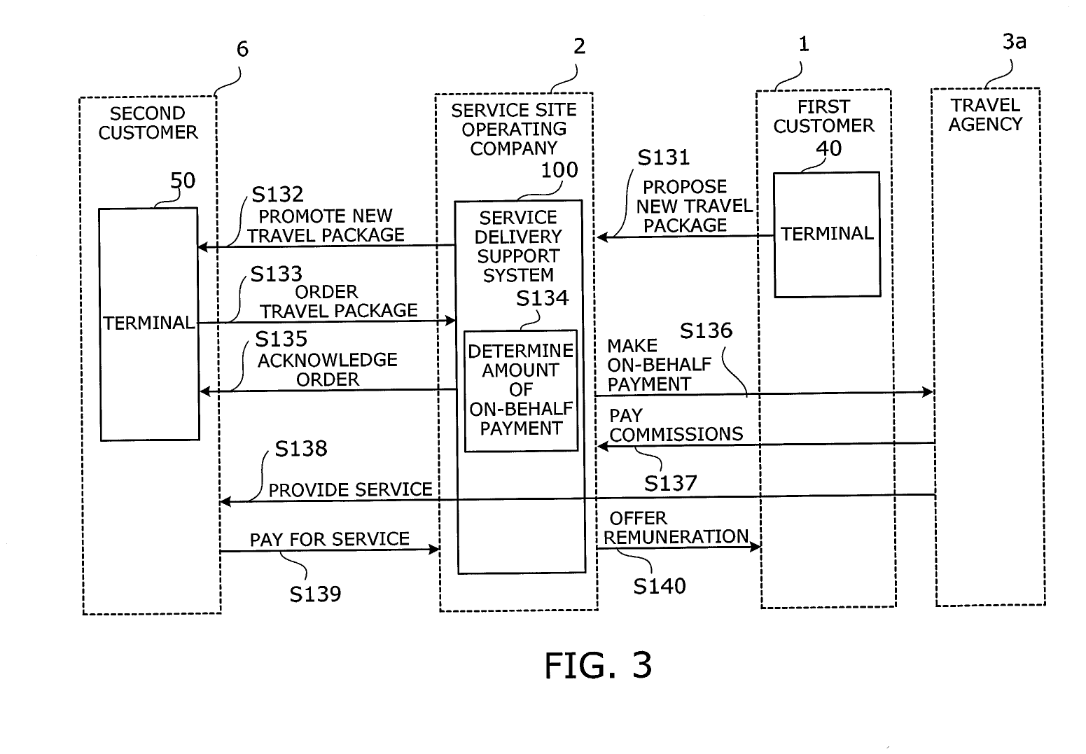

The present embodiment of the invention also permits customers to serve as travel planners who can receive commissions based on the sales performance of travel packages that they proposed. FIG. 3 schematically shows a process of supporting travel proposals according to the present invention. A first customer 1 is registered as a travel planner. He/she issues a proposal for a new travel package to the service delivery support system 100 through his/her terminal 40 (step S131). The service site operating company 2 offers the proposed travel package, together with other packages, to a second customer 6, making their service delivery support system 100 interact with the second customer's terminal 50 (step S132). If the second customer 6 is interested in a certain travel package, he/she sends an order to the service delivery support system 100 through his/her terminal 50 (step S133). The process will then follow the same path as what have been explained in steps S106 to S111 in FIG. 1. That is, the service delivery support system 100 calculates the amount of on-behalf payment (step S134), notifies the second customer 6 of the acknowledgment of the order (step S135), makes payment to the travel agency 3a (step S136) fully or partly for the ordered travel package on behalf of the second customer 6, and receives commissions (step S137). In exchange for the service from the travel agency 3a (step S138), the second customer 6 pays the fee (step S139). Finally, the service site operating company 2 offers some remuneration to the first customer 1 (step S140) in the case the travel package sold to the second customer 6 is what the first customer 1 proposed previously to the service site operating company 2.

Through the above-described process, the first customer 1 can receive remuneration for his/her travel proposal, if it is accepted by other customers as being an excellent plan. The arrangement of the present invention permits the service site operating company 2 to collect travel proposals from many customers, thus providing a variety of tour package products that meet different needs.

The services explained above in FIGS. 1 to 3 may be implemented on a network such as the Internet. The next section will present a specific example of a system which embodies the service functions of the present invention.

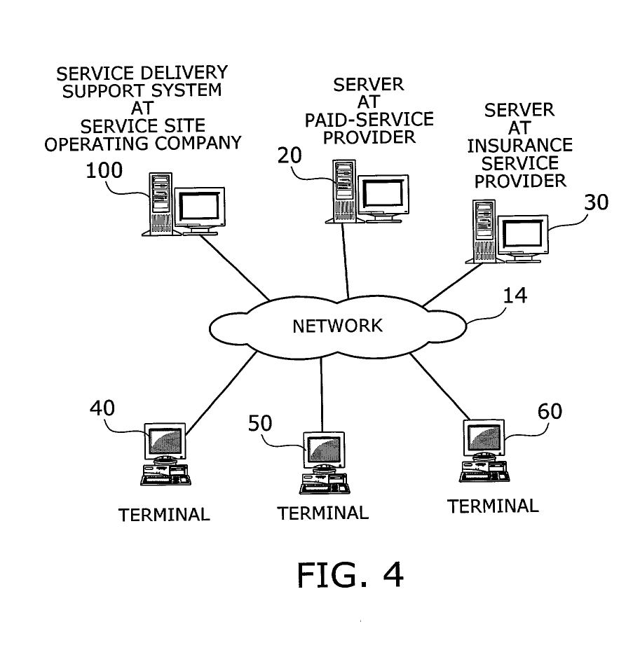

FIG. 4 shows a system structure for assisting delivery of services according to the present invention. This system comprises a service delivery support system 100, a plurality of servers 20 and 30, and a plurality of customer terminals 40, 50, and 60. Those elements are interconnected by a wide area network 14, such as the Internet.

The service delivery support system 100 is implemented as a server that is operated by a service site operating company which offers insurance products and other various support facilities to the users of the terminals 40, 50, and 60. The server 20, on the other hand, is operated by a paid-service provider such as a travel agency. The server 30 is a server of an insurance service provider, such as an insurance company. The terminals 40, 50, and 60 are linked to the service delivery support system 100 to receive support services. Using the terminals 40, 50, and 60, the customers can enroll themselves as contract workers of the service site operating company if they wish. The company provides those registered customers with job support programs. The customers are also given opportunities to propose a new service project for third parties by, for example, sending travel proposals to the service delivery support system 100.

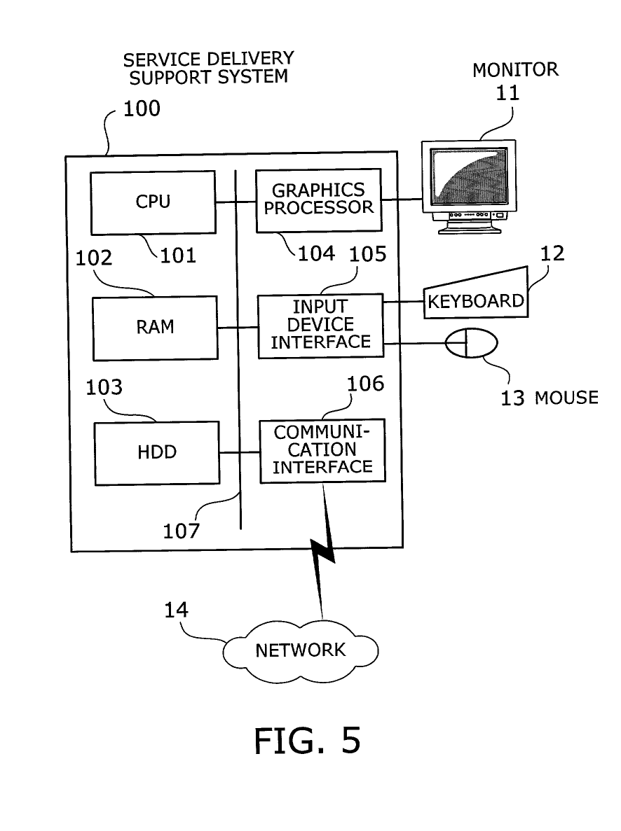

FIG. 5 shows a typical hardware configuration of a service delivery support system according to the present invention. This service delivery support system 100 comprises the following functional elements: a central processing unit (CPU) 101, a RAM 102, a hard disk unit (HDD) 103, a graphics processor 104, an input device interface 105, and a communication interface 106. The CPU 101 controls the system 100 in its entirety, interacting with other elements via a common bus 107.

The RAM 102 temporarily stores at least a part of operating system (OS) programs and application programs that the CPU 101 executes, in addition to other various data objects manipulated at runtime. The HDD unit 103 stores the operating system and application programs. The graphics processor 104 produces video images in accordance with drawing commands from the CPU 101 and displays them on a monitor unit 11 coupled thereto. The input device interface 105 is used to receive signals from external input devices, such as a keyboard 12 and a mouse 13. Those input signals are supplied to the CPU 101 via the bus 107. The communication interface 106 is connected to a wide area network 14, such as the Internet, to allow the CPU 101 to exchange data with other computers.

The processing functions of the present invention are implemented on the above-described hardware platform. While FIG. 5 shows the service delivery support system, similar hardware structures can apply to other servers and terminals involved in the present embodiment of the invention. The next section will provide more details about the processing functions of the present invention by illustrating how the customer interacts with the system 100 through his/her terminal 40.

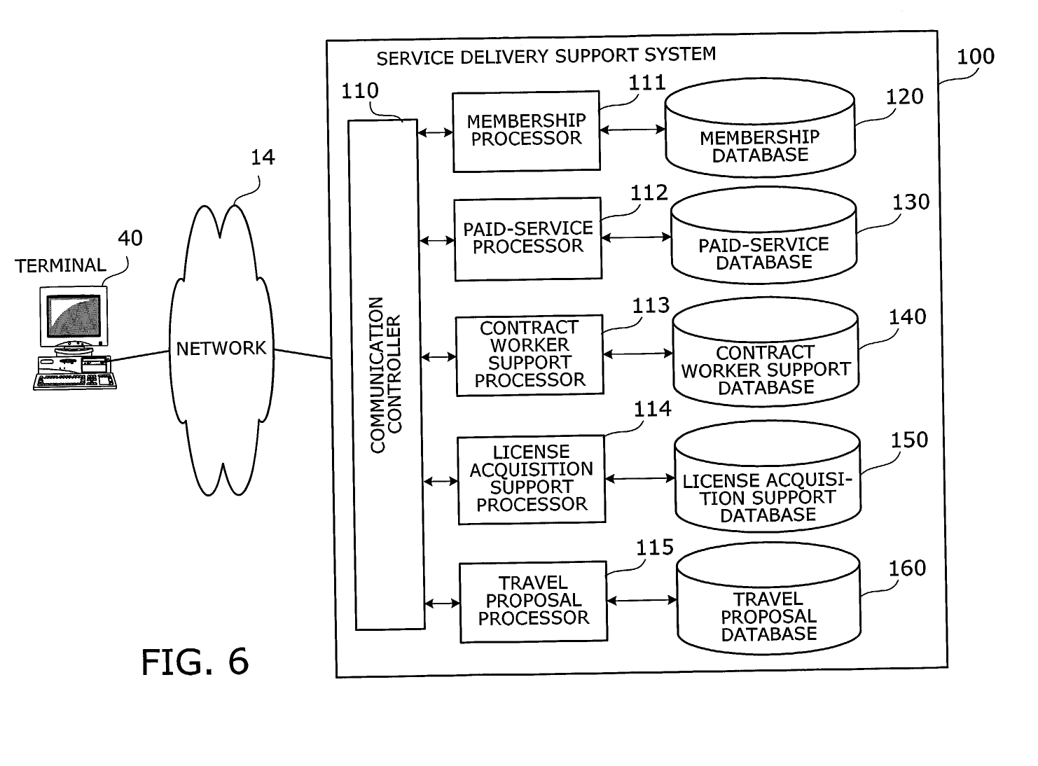

FIG. 6 is a functional block diagram of the service delivery support system 100 according to the present invention. The service delivery support system 100 is constructed as a collection of various processing functions, which include: a communication controller 110, a membership processor 111, a paid-service processor 112, a contract worker support processor 113, a license acquisition support processor 114, and a travel proposal processor 115. Also employed in this system 100 are the following databases: a membership database 120, a paid-service database 130, a contract worker support database 140, a license acquisition support database 150, and a travel proposal database 160.

The communication controller 110 is coupled to all the processors in the service delivery support system 100, so that each incoming request from the network 14 will be delivered to an appropriate processor. The communication controller 110 also delivers processing results of each processor back to the requesting terminal 40.

Briefly, the five processors 111 to 115 and their respective databases 120 to 160 shown in FIG. 6 provide the following functions. First, the membership processor 111 executes a membership registration routine, interacting with the customer terminal 40. Under the control of the membership processor 111, the membership database 120 maintains records of the membership. The paid-service processor 112 offers various paid services to the membership, consulting the paid-service database 130 for available services.

The contract worker support processor 113 serves as an intermediary between insurance companies and some of the membership who are qualified as insurance sales agents. That is, the contract worker support processor 113 helps those qualified members to sign up for job opportunities offered by affiliated insurance companies. The contract worker support processor 113 manages a directory of such members stored in the contract worker support database 140.

Some members need a help for obtaining an insurance agent license. The license acquisition support processor 114 serves those members by giving information about various license acquisition courses. This processor 114 consults the license acquisition support database 150 to find necessary information to support them. Lastly, the travel proposal processor 115 accepts proposals of travel plans from some customers. It offers those plans to other customers. The travel proposal database 160 records those travel proposals.

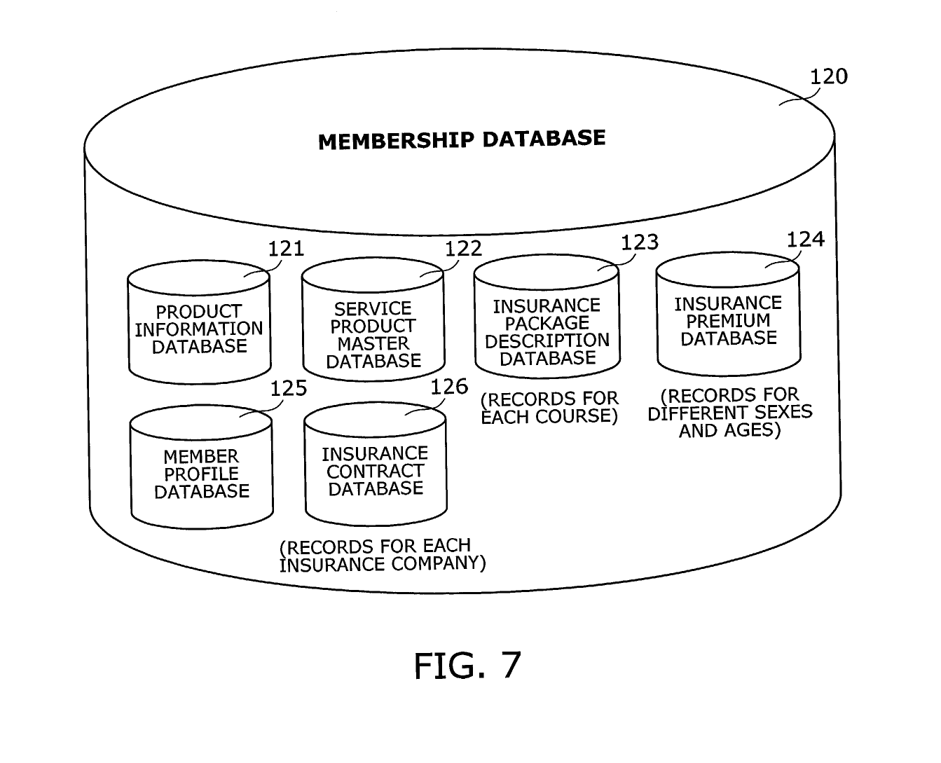

FIG. 7 shows resources constituting the membership database 120. In this example, the membership database 120 is organized as a collection of specialized databases, including: a product information database 121, a service product master database 122, an insurance package description database 123, an insurance premium database 124, a member profile database 125, and an insurance contract database 126. Records in the insurance package description database 123 describe various courses. The insurance premium database 124 stores records for different sexes and ages. The insurance contract database 126 maintains a set of records for each individual insurance company.

The product information database 121 stores records about insurance products that are offered to the members. The details of this product information database 121 will be discussed later. The service product master database 122 maintains master data of insurance products to which the paid services are linked. The insurance package description database 123 contains the specifics of each insurance package registered in the service product master database 122. The insurance premium database 124 stores data about the premium of each insurance package being offered to the members. The premium of an insurance product depends on, for example, the gender and age of the purchaser.

The member profile database 125 stores the profile of each member, details of which will be explained later. The insurance contract database 126 stores detailed records of insurance contracts signed between customers and each insurance company.

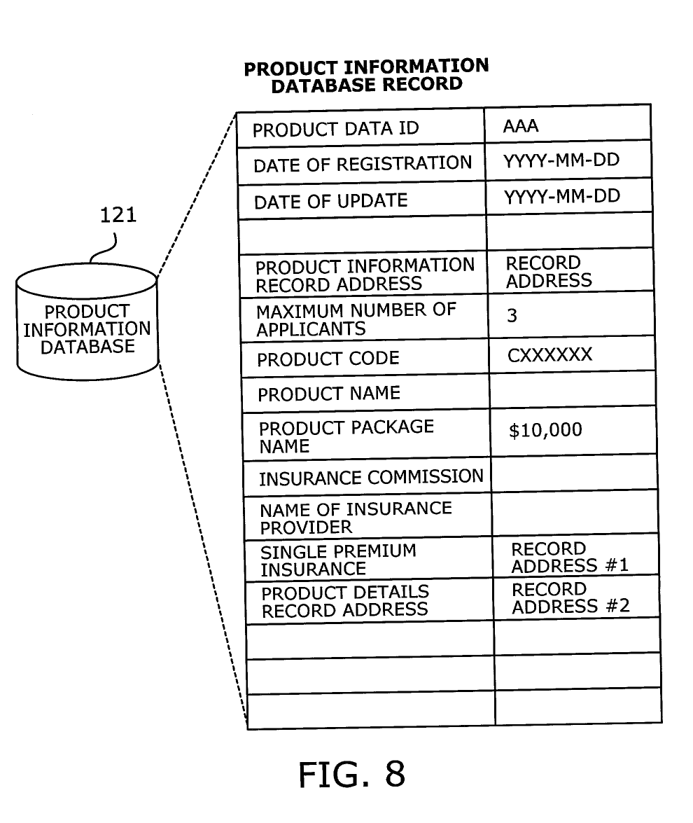

FIG. 8 shows an example of a record stored in the product information database 121. Each record in this database 121 gives the information on a particular insurance product being offered to the membership. This example record of FIG. 8 has the following data fields: “Product Data ID,” “Date of Registration,” “Date of Update,” “Product Information Record Address,” “Maximum Number of Applicants,” “Product Code,” “Product Name,” “Product Package Name,” “Insurance Commission,” “Name of Insurance Provider,” “Single Premium Insurance,” “Product Details Record Address,” and others.

The “Product Data ID” field contains the identifier assigned to this product record. The “Date of Registration” field indicates when the record was entered to the product information database 121 for the first time. The “Date of Update” field indicates the date of the last update made to the record. The “Product Information Record Address” field contains the address of an object that describes the details of the product. The “Maximum Number of Applicants” field shows how many people can apply for this product. The “Product Code” field contains the identifier assigned to the product itself. The “Product Name” field shows the family name of the product. The “Product Package Name” field shows the name of a package when the product is provided as a family of predefined packages. The “Insurance Commission” field indicates how much commission will be paid to sales agents. The “Insurance Provider Name” field gives the name of an insurance company that provides the insurance product. The “single premium insurance” field shows the amount of the premium that the applicant has to pay for the insurance. The “Product Details Record Address” field contains a pointer linking to the place where the detailed description of this product is found.

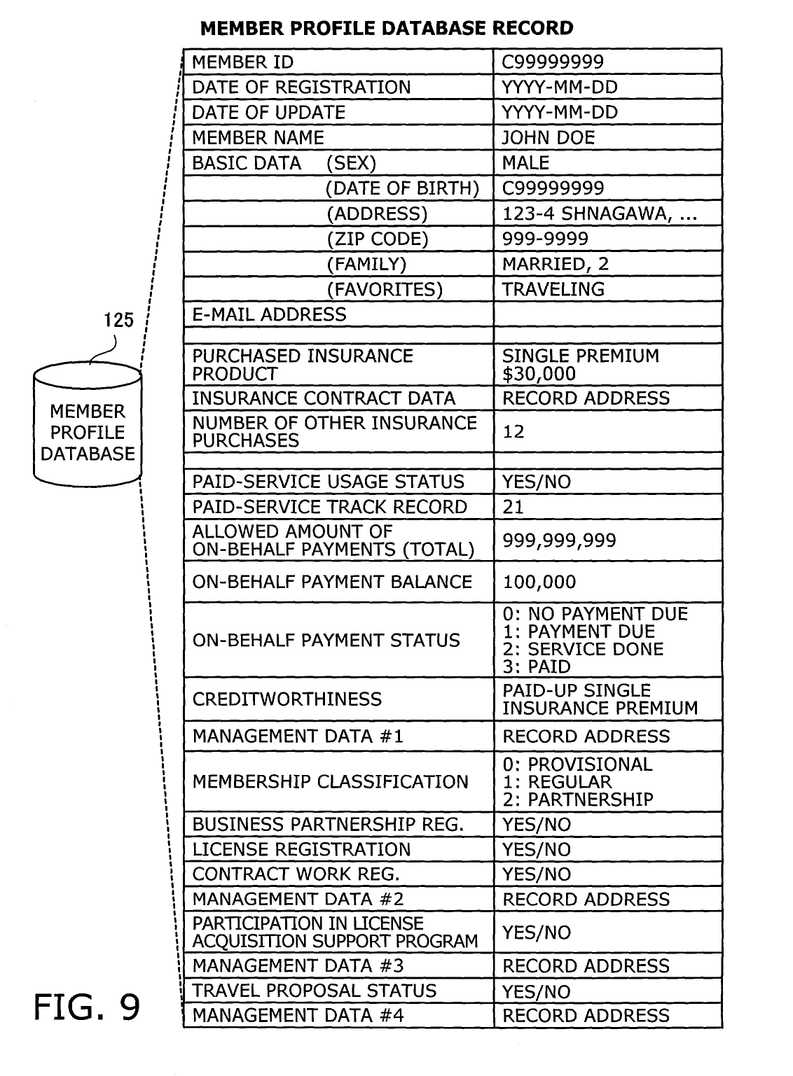

FIG. 9 shows a record of the member profile database 125. Each record of this database 125 provides the profile of a particular member, including his/her personal information. The example record of FIG. 9 comprises the following data fields: “Member ID,” “Date of Registration,” “Date of Update,” “Member Name,” “Basic Data” “E-mail Address,” “Purchased Insurance Package,” “Purchased Insurance Product,” “Number of Other Insurance Purchases,” “Paid Service Usage Status,” “Paid Service Track Record,” “Allowed Amount of On-behalf Payments (Total),” “On-behalf Payment Balance,” “On-behalf Payment Status,” “Creditworthiness,” “Management Data #1,” “Membership Classification,” “Business Partnership Registration,” “License Registration,” “Contract Worker Registration,” “Management Data #2,” “Participation in License Acquisition Support Program,” “Management Data #3,” “Travel Proposal Status,” “Management Data 4,” and so on.

The “Member ID” field contains the identification code of a customer (member) who purchased an insurance product with support service opportunities. The “Date of Registration” field tells when the customer was registered as a member. The “Date of Update” field indicates when the last update was made to this profile record. The “Member Name” field shows the name of the member, and the “Basic Data” field shows his/her personal information, which include: “Sex,” “Date of Birth,” “Address,” “ZIP Code,” “Family,” and “Favorites.”

The “E-mail Address” field contains the e-mail address of the member. The “Purchased Insurance Package” field shows which insurance product the member purchased. The “Purchased Insurance Product” field contains an address pointer linking to a record that describes in detail the insurance package with support service opportunities purchased by the member. The “Number of Other Insurance Purchases” field shows how many other insurance policies the member has. Those insurance policies have no support service opportunities. The “Paid Service Usage Status” field indicates whether the member used any paid services in the past. The “Paid Service Track Record” shows how many times the member used paid services. The “Allowed Amount of On-behalf Payments (Total)” field shows the total amount of money the system would pay on behalf of the member when he/she uses paid services. The “On-behalf Payment Balance” field shows the current balance of the on-behalf payments for the member. The “On-behalf Payment Status” field is an indicator of the current status of the payment for paid services. When this indicator has a value of “0,” it means that the member has no payment due. The value “1” indicates nonzero balance of on-behalf payments. The value “2” denotes that the service purchased with on-behalf payment has been completed, but the purchaser has not yet paid the fee. The value “3” means that the member has paid the service fee to the service site operating company. The “Creditworthiness” field contains information such as the paid-up amount of the member's single premium insurance. The “Management Data #1” field contains an address pointer linking to a record of on-behalf payment for service fees.

The “Membership Classification” field contains a value showing the type of membership that the customer holds. More specifically, the value “0” means the customer is a provisional member who has applied for an insurance to meet the basic requirement of membership, but not yet paid the premium. The value “1” indicates that the customer is a regular member who has already paid up the insurance premium. The value “2” indicates that the customer is a business partnership member who has signed up as an insurance sales agent. Actually, the business partnership members are divided into two categories: contract workers and non-contract workers. Non-contract business partners do not have agent licenses at the moment, although they wish to work as an agent in the future. For this reason, they are eligible to participate in the license acquisition support program. On the other hand, those who have insurance sales licenses can enroll themselves as business partnership members who will serve as contract workers. They are entitled to receive commissions, depending on their performance in the insurance sales activities.

The “Business Partnership Registration” field indicates whether the customer is registered as a business partnership member. The “License Registration” field indicates whether the member owns any license (such as sales agent license for property and casualty insurance). The “Contract Worker Registration” field indicates whether the member is registered as a contract worker. The “Management Data #2” field contains an address pointer linking to a record that describes the membership classification and the like. The “Participation in License Acquisition Support Program” field shows whether the member is participating in a license acquisition support program. The “Management Data #3” field contains an address pointer linking to a record concerning the license acquisition support program. The “Travel Proposal Status” field indicates whether the member has ever proposed any travel plans. The “Management Data #4” field contains an address pointer linking to a record concerning travel proposals.

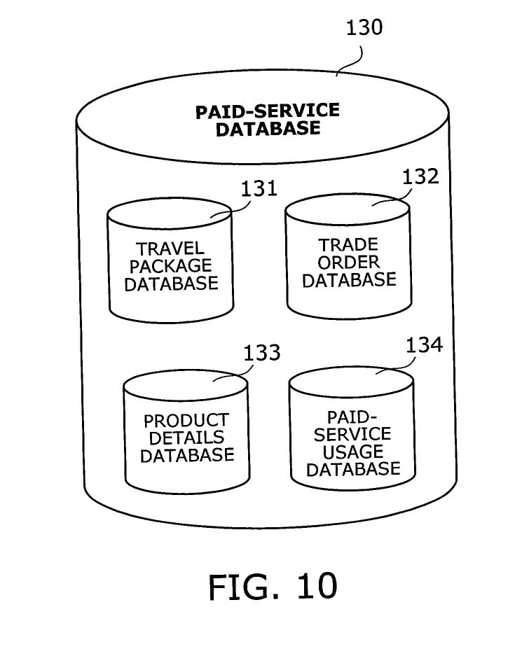

FIG. 10 shows resources constituting the paid-service database 130. The paid-service database 130 is organized as a collection of the following databases: a travel package database 131, a trade order database 132, a product details database 133, and a paid-service usage database 134. The travel package database 131 stores records about travel packages for sale. The trade order database 132 stores records of product transactions and orders. The product details database 133 stores specifics of each product. The paid-service usage database 134 stores records concerning paid services being used by the membership.

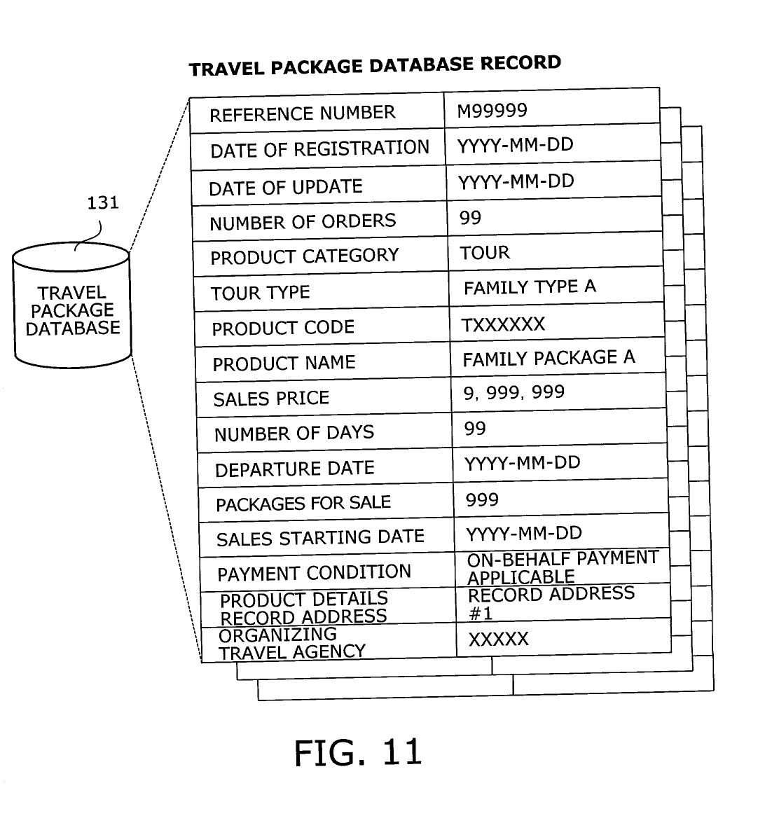

FIG. 11 shows an example of a record stored in the travel package database 131. This record contains the following data fields describing a particular travel package: “Reference Number,” “Date of Registration,” “Date of Update,” “Number of Orders,” “Product Category,” “Tour Type,” “Product Code,” “Product Name,” “Sales Price,” “Number of Days,” “Departure Date,” “Packages for Sale,” “Sales Starting Date,” “Payment Condition,” “Product Details Record Address,” “Organizing Travel Agency”.

The “Reference Number” field contains an identifier which is assigned to this travel package record. The “Date of Registration” field indicates when this record was entered to the travel package database 131 for the first time. The “Date of Update” field indicates when the last update was made to the record. The “Number of Orders” field shows the number of orders received for the travel package. The “Product Category” and “Tour Type” fields show the major classification and minor classification of the travel package. The “Product Code” field contains the identifier of the travel package. The “Product Name” field shows the name of the travel package. The “Sales Price” field shows the price asked for the travel package. The “Number of Days” field gives the duration of the tour. The “Departure Date” field shows when the planned tour will start. The “Packages for Sale” field defines how many people are allowed to join the tour. The “Sales Starting Date” field shows when the sales of this travel package begins. The “Payment Condition” field indicates what payment methods are accepted. The example of FIG. 11 shows that the membership can use an on-behalf payment service when buying this travel package. The “Product Details Record Address” field contains an address pointer linking to the detailed description of the product. The “Organizing Travel Agency” field shows which travel agency is selling the travel package.

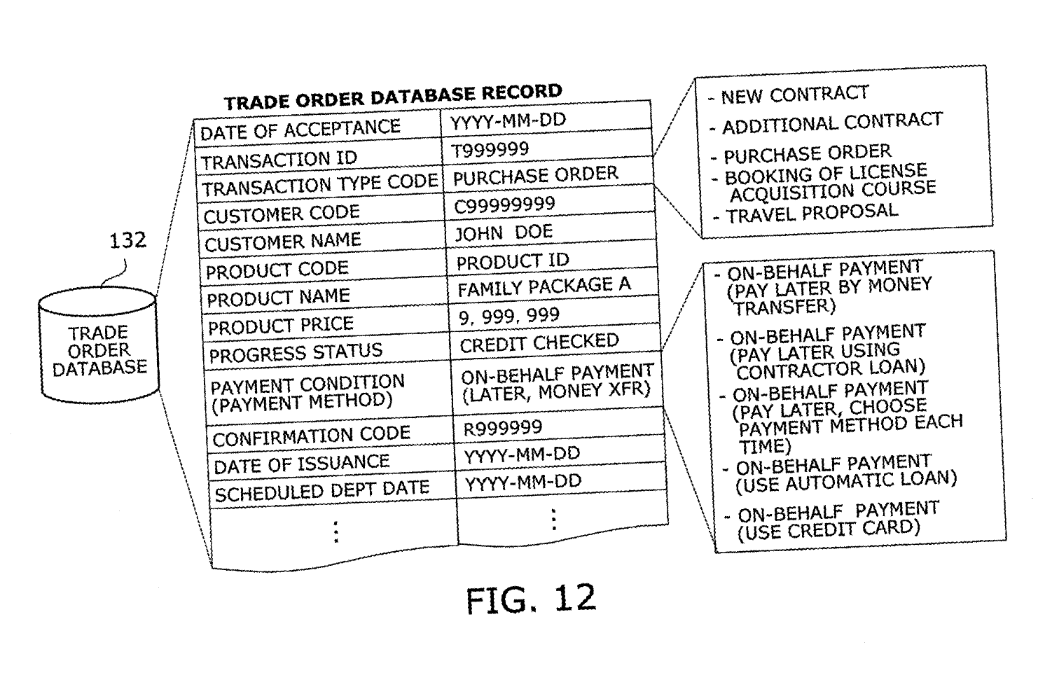

FIG. 12 shows an example of a record of the trade order database 132. This record contains the following data fields describing a particular purchase order: “Date of Acceptance,” “Transaction ID,” “Transaction Type Code,” “Customer Code,” “Customer Name,” “Product Code,” “Product Name,” “Product Price,” “Progress Status,” “Payment Condition (Payment Method),” “Confirmation Code,” “Date of Issuance,” and “Scheduled Departure Date.”

The “Date of Acceptance” field shows when this product purchase order was accepted by the system. The “Transaction ID” field shows the identification code given to this product transaction. The “Transaction type code” field contains an identifier that represents what type of transaction was conducted. The transaction types include: new contract, additional contract, purchase order, booking of license acquisition course, and travel proposal. The “Customer Code” field contains a code that identifies the customer who placed the purchase order, and the “Customer Name” field shows his/her name. The “Product Code,” “Product Name,” and “Product Price” fields show the code, name, and price of the ordered product, respectively. The “Progress Status” field indicates the current state of order processing. For example, the record of FIG. 12 shows that the creditworthiness of the purchaser has been checked. The “Payment Condition (Payment Method)” field indicates which payment method was selected by the purchaser. The system allows several payment options as follows: “On-Behalf Payment (Pay Later by Money Transfer),” “On-Behalf Payment (Pay Later Using Contractor Loan),” “On-Behalf Payment (Pay Later, Choose Payment Method Each Time),” “On-Behalf Payment (Use Automatic Loan),” “On-Behalf Payment (Use Credit Card).” The “Confirmation Code” field shows a code indicating the acceptance of the order. The “Date of Issuance” field shows when the order was issued. The “Scheduled Departure Date” field shows the scheduled departure date in the case the ordered product is a tour package.

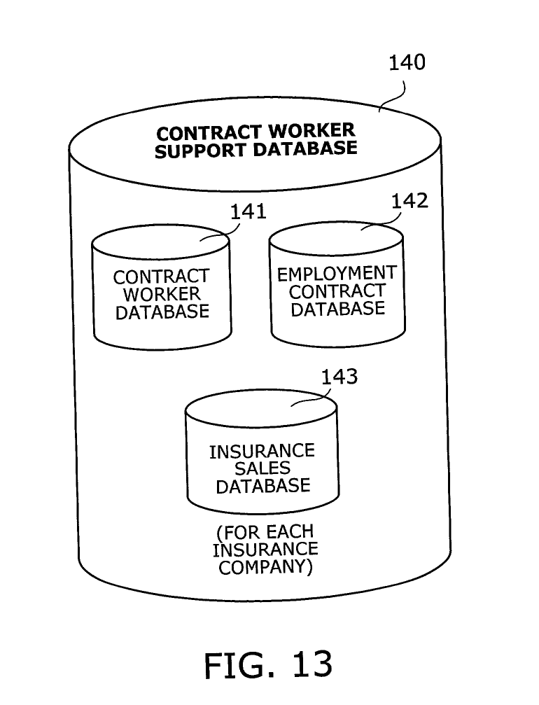

FIG. 13 shows resources constituting the contract worker support database 140. The contract worker support database 140 is organized as a collection of the following databases: a contract worker database 141, an employment contract database 142, and an insurance sales database 143. The contract worker database 141 stores records of the members who agreed to be employed as contract workers. The employment contract database 142 stores the contract worker agreement which are signed by the business partnership members and service site operating company. The insurance sales database 143 records the achievements of contract workers separately for each insurance company.

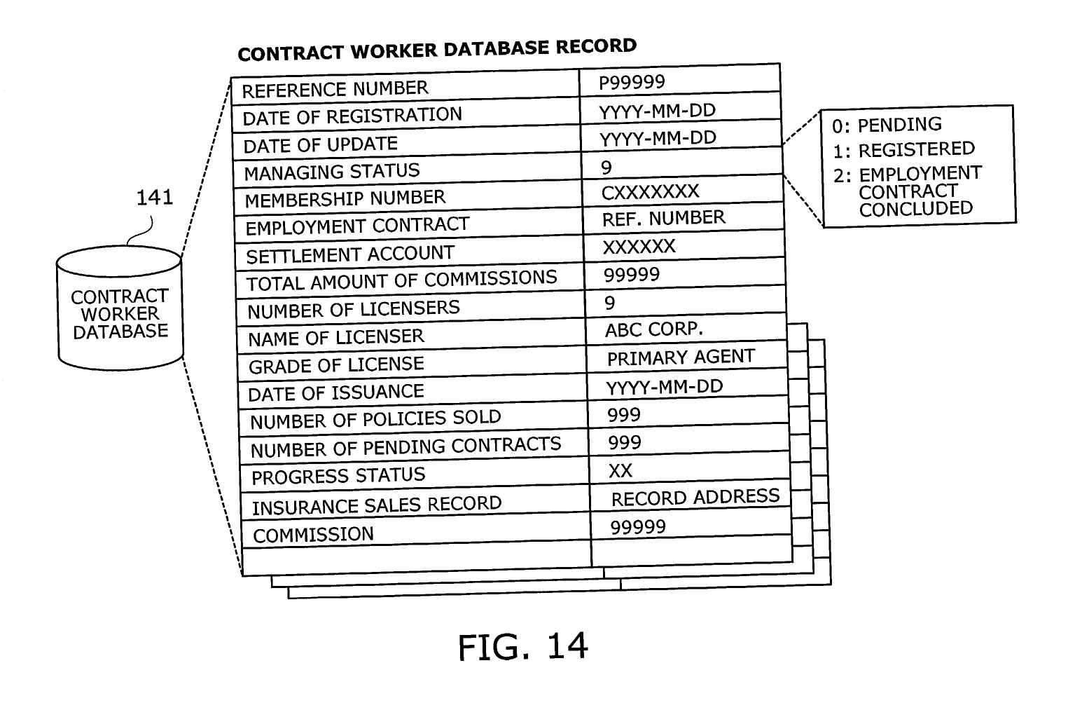

FIG. 14 shows an example of a record stored in the contract worker database 141. This record consists of the following data fields describing a particular contract worker: “Reference Number,” “Date of Registration,” “Date of Update,” “Managing Status,” “Membership Number,” “Employment Contract,” “Settlement Account,” “Total Amount of Commissions,” and “Number of Licensers.” Further, the record has extended fields that are in proportion to the number of licensers. Such extended fields include: “Name of Licenser,” “Grade of License,” “Date of Issuance,” “Number of Policies Sold,” “Number of Pending Contracts,” “Progress Status,” “Insurance Sales Record,” and “Commission.”

The “Reference Number” field contains an identifier that is assigned to this particular contract worker record. The “Date of Registration” field indicates when this record was entered to the contract worker database 141 for the first time. The “Date of Update” field indicates when the last update was made to this record. The “Registration Status” field indicates the current status of this contract worker. More specifically, this field may have a value of “0,” which indicates that his/her registration is pending. The value “1” indicates that he/she is registered. The value “2” means that the employment contract has been established. The “Membership Number” field contains the membership ID of the registered contract worker. The “Employment Contract” field stores the reference number of an employment contract relevant to the contract worker. The “Settlement Account” field stores the account number of a financial institution, which the contract worker uses to receive commissions from the service site operating company. The “Total Amount of Commissions” field records the total amount of commissions paid to the contract worker. The “Number of Licensers” field shows how many insurance companies authorize the contract worker as their agent.

The remaining data fields are provided repeatedly, one set for each insurance company. The “Name of Licenser” field shows the name of the license issuing insurance company. The “Grade of License” field indicates what grade of license (e.g., primary agent, senior agent) the contract worker has. The “Date of Issuance” field shows when the contract worker obtained his/her highest-grade license. The “Number of Policies Sold” field records the number of insurance policies that the contract worker has sold to third parties. The “Number of Pending Contracts” field shows how many of the sold insurance policies are pending because of, for example, their unpaid premiums. The “Progress Status” field shows the current status (e.g., new contract in process of registration) of the insurance policies sold by the contract worker. The “Insurance Sales Record” field contains an address pointer linking to a relevant new contract record. The “Commission” field shows the amount of remuneration that the licenser agreed to pay to the contract worker.

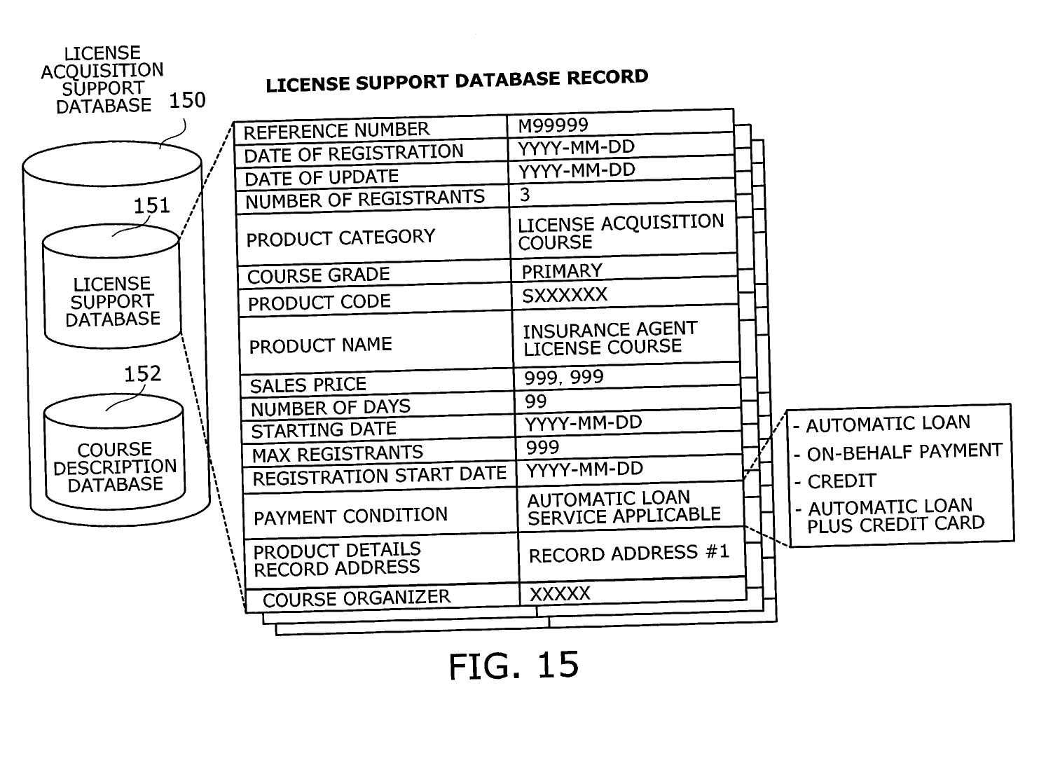

FIG. 15 shows resources constituting the license acquisition support database 150. This database 150 comprises a license support database 151 and a course description database 152. The license support database 151 stores data of license acquisition support programs. The course description database 152 maintains the details of each license acquisition course.

FIG. 15 also shows an example of a record of the license support database 151. This record describes a particular license course, consisting of the following data fields: “Reference Number,” “Date of Registration,” “Date of Update,” “Number of Registrants,” “Product Category,” “License Acquisition Course,” “Product Code,” “Product Name,” “Sales Price,” “Number of Days,” “Starting Date,” “Maximum Registrants,” “Sales Starting Date,” “Payment Condition,” “Product Details Record Address,” and “Organizing Company.”

The “Reference Number” field contains an identifier that is assigned to this particular record of the license acquisition support program. The “Date of Registration” field indicates when this record was entered to the license support database 151 for the first time. The “Date of Update” field indicates when the last update was made to this record. The “Number of Registrants” field indicates how many people have signed up for the license course that this record describes. The “Product Category” and “Course Grade” fields show the major classification and minor classification of the license course. The “Product Code” and “Product Name” fields show the product identifier and the title of the license course. The “Sales Price” field is the fee asked for the license course. The “Number of Days” field shows the duration of the license course. The “Starting Date” field indicates when the license course will begin. The “Maximum Registrants” field shows the number of course participants that can be registered. The “Sales Starting Date” field shows when the booking of the course starts. The “Payment Condition” field describes what payment methods are acceptable. In the example of FIG. 15, the following payment options are available: automatic loan, on-behalf payment, payment by credit card, and combined use of automatic loan and credit card payment. The “Product Details Record Address” field contains an address pointer linking to the detailed description of the course. The “Course Organizer” field shows the name of the company that organizes the course.

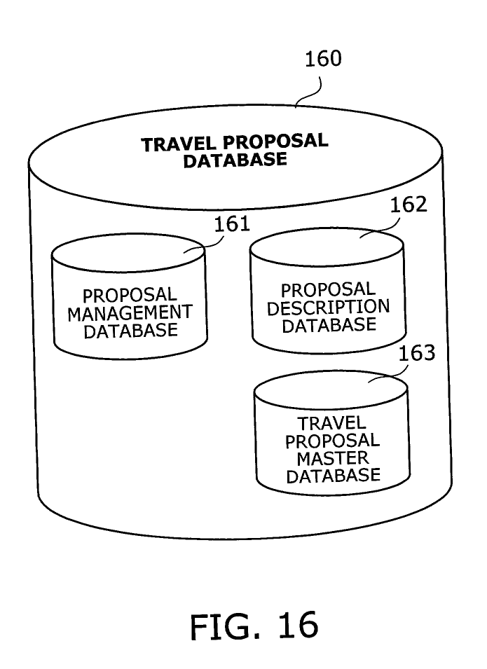

FIG. 16 shows resources constituting the travel proposal database 160. This database 160 is organized with the following three databases: a proposal management database 161, a proposal description database 162, and a travel proposal master database 163. The proposal management database 161 stores the summaries of proposed projects. The proposal description database 162 stores the details of each proposal. The travel proposal master database 163 stores various marketing information to promote the travel proposals to third parties.

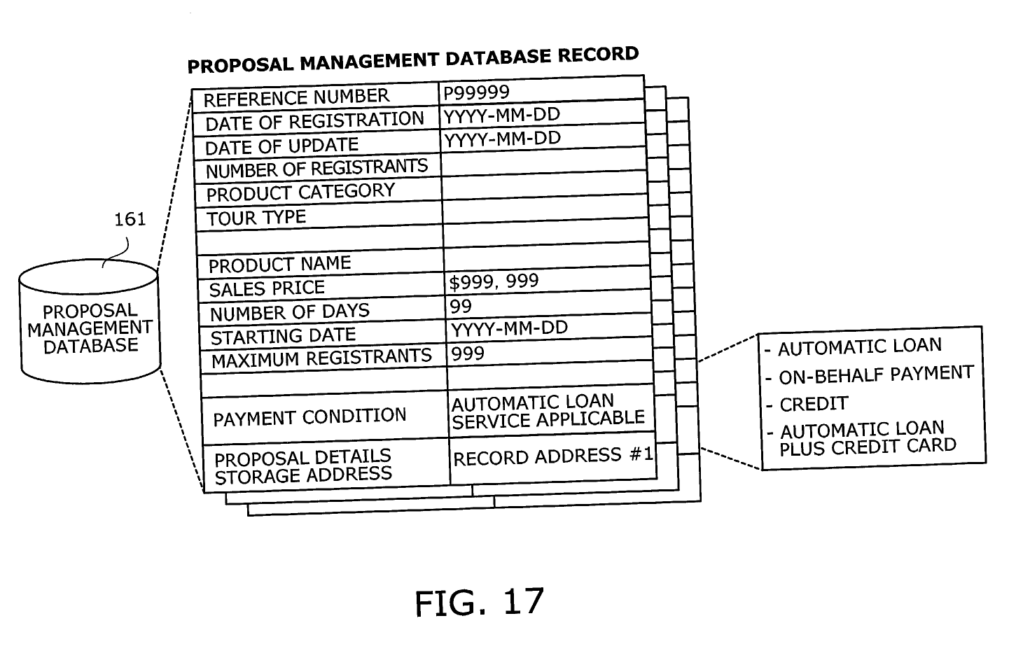

FIG. 17 shows an example of a record stored in the proposal management database 161. This record describes a particular travel proposal, providing for the following data fields: “Reference Number,” “Date of Registration,” “Date of Update,” “Number of Registrants,” “Product Category,” “Tour Type,” “Product Name,” “Sales Price,” “Number of Days,” “Starting Date,” “Maximum Registrants,” “Payment Condition,” and “Proposal Details Storage Address.”

The “Reference Number” field contains an identifier that is assigned to this particular travel proposal. The “Date of Registration” field indicates when this record was entered to the proposal management database 161 for the first time. The “Date of Update” field indicates when the last update was made to this record. The “Number of Registrants” field shows the number of registrants who signed up for a travel package being marketed as a result of the proposal. The “Product Category” and “Tour Type” fields show the major and minor classifications of the travel proposal. The “Product Name” field shows the name of the product that is sold according to the present travel proposal. The “Sales Price” field indicates the price asked for the product. The “Number of Days” field shows the duration of the proposed tour. The “Starting Date” field shows the departure date of the proposed tour. The “Maximum Registrants” field shows the upper limit of tour participants that can be registered. The “Payment Condition” field describes what payment methods are acceptable when tour participants pay for the proposed tour package. In the example of FIG. 17, the following payment options are available: automatic loan, on-behalf payment, payment by credit card, and combined use of automatic loan and credit card payment. The “Project Proposal Storage Address” field contains an address pointer linking to a detailed description of the proposed tour package.

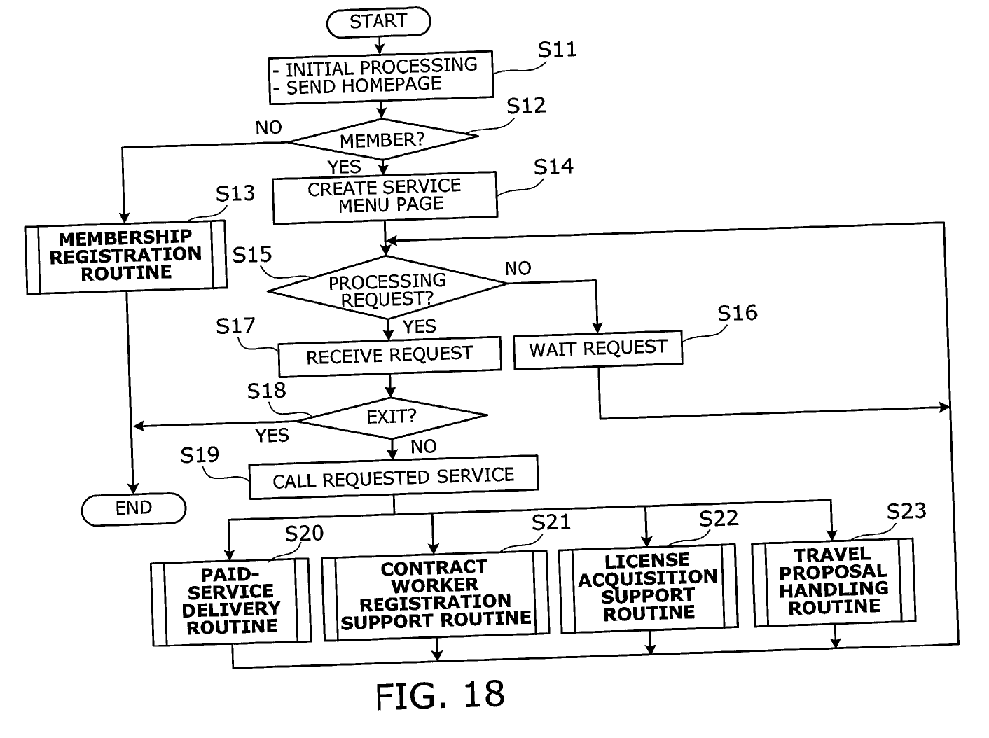

With the various database records described above, the service delivery support system 100 provides the following processing services. FIG. 18 is a flowchart of a process executed by the service delivery support system 100 of the present invention. This process is invoked when the terminal 40 attempts to make access to the homepage of the service site. The process comprises the following steps.

(S11) Upon receipt of a homepage request from the terminal 40, the communication controller 110 in the service delivery support system 100 performs initial processing and homepage processing. The initial processing includes tasks of, for example, sending HTTP cookies to the requesting terminal 40 for the identification of the terminal 40 in later interactions. The term “homepage” refers to the default page in a website. While having a plurality of pages and data items as a web server, the service delivery support system 100 provides the terminal 40 with the homepage data at this initial step S11.

(S12) The customer sitting at the terminal 40 interacts with the service delivery support system 100 through the homepage. Based on the actions sent from the terminal 40, the communication controller 110 determines whether the customer is a registered member of the service site. If so, the process advances to step S14. If not, the process branches to step S13.

(S13) The service delivery support system 100 activates its integral membership processor 111 to communicate with the terminal 40, so that it will help the customer sign up for the membership. The process is terminated upon completion of the membership sign-up. Details of this step S13 will be described in a later section.

(S14) The communication controller 110 sends a service menu page to the terminal 40.

(S15) The communication controller 110 determines whether the terminal 40 has any processing request in the service menu page. If there is, the process advances to step S17. If not, the process goes to step S16.

(S16) The communication controller 110 waits for a processing request from the terminal 40.

(S17) The communication controller 110 receives the processing request from the terminal 40.

(S18) The communication controller 110 determines whether the terminal 40 is demanding the termination of the present session. If so, the process advances to the current process is terminated. Otherwise, the process proceeds to step S19.

(S19) The communication controller 110 directs the received processing request to an appropriate processor in the service delivery support system 100, depending on the content of the request. More specifically, if the customer is making an application for a specific paid service, the request is delivered to the paid-service processor 112 to process it at step S20. If the customer is wishing to become a contract worker, the request is delivered to the contract worker support processor 113 to process it at step S21. If the customer is applying for a license course, the request is passed to the license acquisition support processor 114 to handle it at step S22. If the customer is proposing a travel plan, the request is forwarded to the travel proposal processor 115 to process it at step S23.

(S20) The paid-service processor 112 executes a paid service delivery routine according to the processing request sent from the terminal 40 (the details will be described later). When this routine is completed, the process returns to step S15.

(S21) The contract worker support processor 113 executes a contract worker registration support routine according to the processing request sent from the terminal 40. When this routine is completed, the process returns to step S15.

(S22) The license acquisition support processor 114 executes a license acquisition support routine according to the processing request sent from the terminal 40. When this routine is completed, the process returns to step S15.

(S23) The travel proposal processor 115 executes a travel proposal handling routine according to the processing request sent from the terminal 40. When this routine is completed, the process returns to step S15.

Through the above steps, the service delivery support system 100 handles a processing request given from the terminal 40, allocating a processor that is suitable for the content of the request. The service delivery support system 100 sends appropriate pages to the terminal 40, and the customer interacts with the system 100 through such pages displayed on the terminal 40, where he/she can browse the information and issue a specific request by operating input devices.

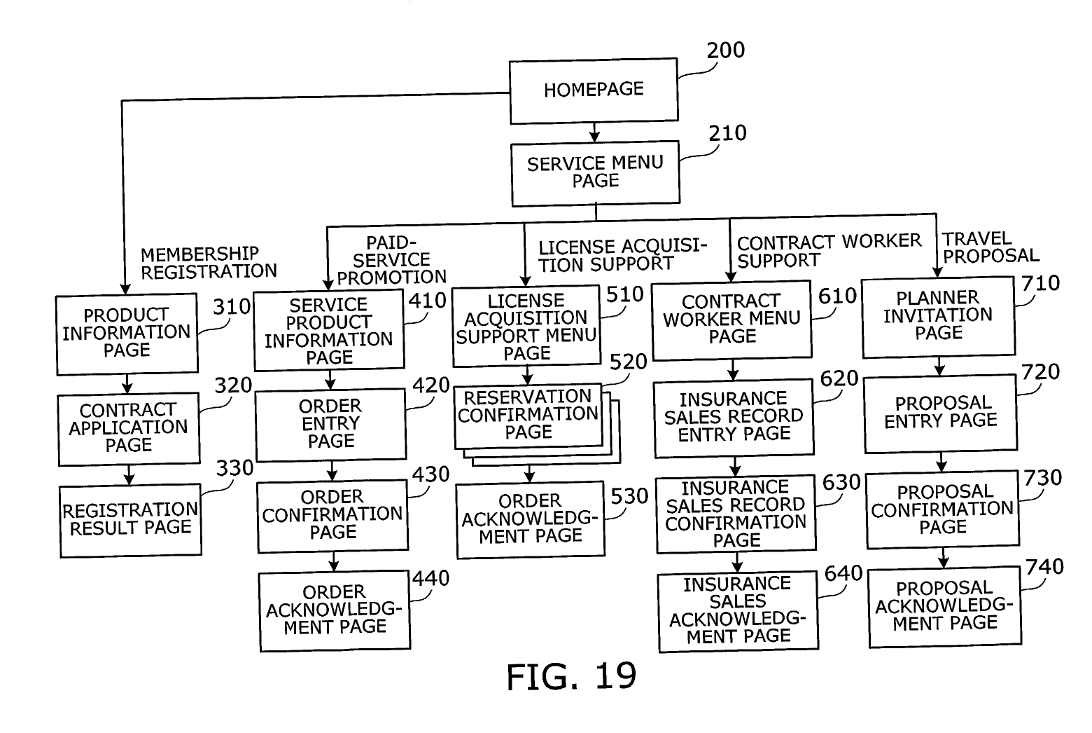

FIG. 19 schematically shows the transition of pages which appear on the terminal 40. Note that FIG. 19 only shows a typical scenario; the sequence of pages may change in a variety of ways, depending on the customer's reactions.

At the first access to the service delivery support system 100, the terminal 40 receives a homepage 200. In this homepage 200, the customer may invoke a membership registration process. In response to this request, the service delivery support system 100 returns a product information page 310 to the terminal 40. When the customer finishes the product information page 310 with a certain action, the terminal 40 then receives a contract application page 320. The customer fills out an application form on this page 320 and submits it to the service delivery support system 100. The service delivery support system 100 accepts the application, thus sending out a registration result page 330 to indicate the acknowledgment.

Referring back to the homepage 200, the customer logs in to the service delivery support system 100 by entering his/her ID and password. This happens if the customer is a registered member. The customer is then invited to a service menu page 210, where he/she can choose a desired service from a menu. The selection of a particular menu item takes the customer to a service-specific page. More specifically, when the customer selects a menu item about paid services, a service product information page 410 pops up on the screen of the terminal 40. When the customer selects a menu item about license acquisition support programs, he/she will be taken to a license acquisition support menu page 510. When the customer selects a menu item about the contract worker support program, the system 100 will create and send a contract worker menu page 610 to the terminal 40. When the customer selects a menu item about travel proposals, he/she will then see a planner invitation page 710 displayed on the terminal 40.

Suppose that the customer has ordered a service product in the service product information page 410. That action takes the customer to an order entry page 420. When the customer finishes with the order entry page 420, the system 100 requests confirmation by sending an order confirmation page 430 to the terminal 40. The customer checks this order confirmation page 430, and then he/she moves to an order acknowledgement page 440.

The customer may apply for a license course in the license acquisition support menu page 510, which takes him/her to a reservation confirmation page 520. The present embodiment of the invention provides for a plurality of reservation confirmation pages 520 to handle different processing needs. When the customer finishes with a reservation confirmation page 520, the service delivery support system 100 sends an order acknowledgement page 530 to the terminal 40.

The customer may have a new sales record to enter in the contract worker menu page 610, which takes him/her to an insurance sales record entry page 620. The customer then enters data in the insurance sales record entry page 620 and moves to the insurance sales record confirmation page 630. When the customer has checked the insurance sales record confirmation page 630, the service delivery support system 100 sends an insurance sales acknowledgment page 640 to the terminal 40.

The customer may have a new proposal to enter in the planner invitation page 710. The service delivery support system 100 then takes the customer to a proposal entry page 720, where he/she enters data in the proposal entry page 720 and moves to a proposal confirmation page 730. When the customer has checked the proposal confirmation page 730, the service delivery support system 100 sends a proposal acknowledgment page 740 to the terminal 40.

The next section will focus into each specific processing functions implemented in the service delivery support system 100, following the above-described page transitions.

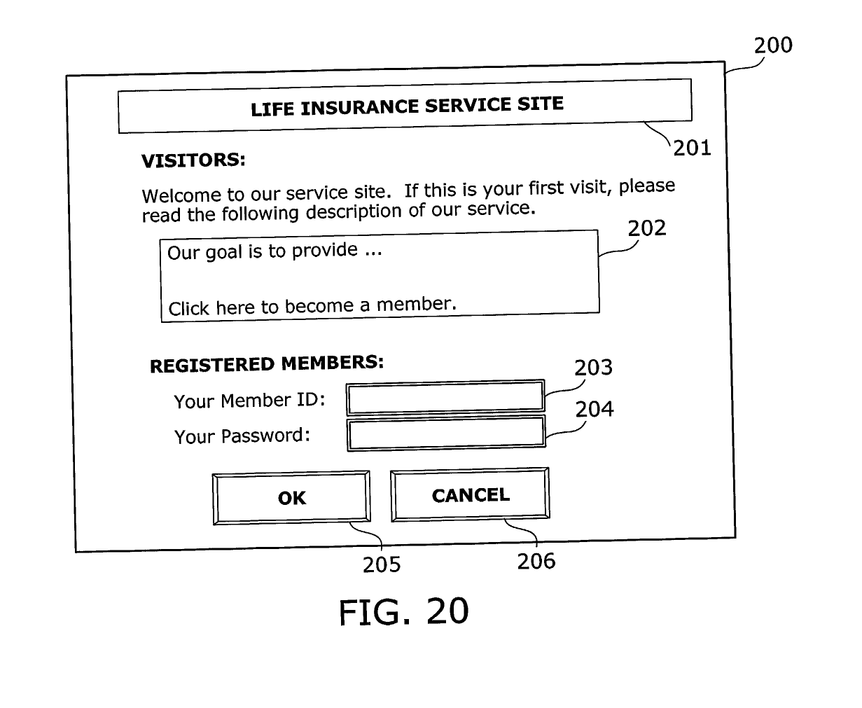

FIG. 20 shows an example of the homepage 200. This homepage 200 is composed of a title bar 201, a service guidance area 202, a member ID field 203, a password entry field 204, an OK button 205, and a CANCEL button 206. The title of the homepage 200 is shown on the title bar 201. In the example of FIG. 20, the page is entitled “Life Insurance Service Site.” The service guidance area 202 contains a message to visitors, or nonmembers, which also serves as a link to a membership signup service. A click on the service guidance area 202 will invoke a membership registration request to the service delivery support system 100.

The member ID field 203 is a text box for a registered member to enter his/her identifier (member ID). The password entry field 204 is a text box to enter his/her password associated with the member ID. The customer hits the OK button 205 to log in to the system 100 after entering his/her member ID and password. When this OK button 205 is pressed, the entered member ID and password are transmitted to the service delivery support system 100 as authentication data of the customer. The customer may want to press the CANCEL button 206 to cancel his/her login attempt, clearing the current data in the member ID field 203 and password entry field 204.

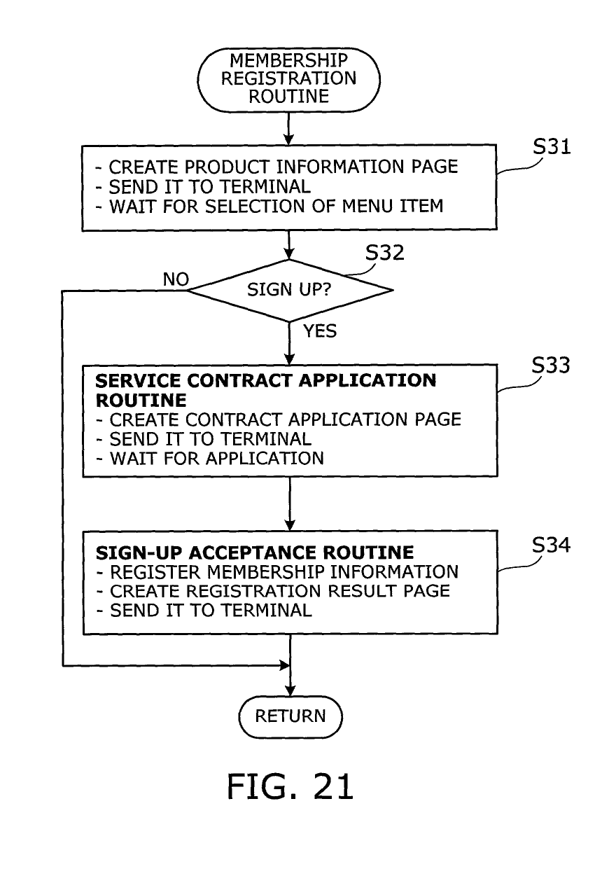

A membership registration routine is called up by a click on the service guidance area 202 in the homepage 200 of FIG. 20. FIG. 21 is a flowchart of this membership registration routine, which comprises the following steps.

(S31) In response to the membership registration request sent from the terminal 40, the membership processor 111 creates a product information page 310, and sends it back to the terminal 40. The membership processor 111 then enters to an idle state, waiting for the customer to select a menu item.

(S32) Receiving a processing request from the terminal 40, the membership processor 111 determines whether the customer is requesting membership. If so, the process advances to step S33. If not, the membership processor 111 exits from the member registration routine, thus concluding the service delivery supporting process of FIG. 18.

(S33) The membership processor 111 executes a service contract application routine. More specifically, the membership processor 111 creates a contract application page 320 and sends it to the terminal 40. The membership processor 111 then enters to an idle state, waiting for the customer to submit an application.

(S34) Upon receipt of a service contract application, the membership processor 111 executes a sign-up acceptance routine. More specifically, the membership processor 111 enters the received application data to the membership database 120. It also creates a registration result page 330 and sends the page to the terminal 40, thus concluding the membership registration routine. The service delivery support system 100 then exits from the service delivery supporting process of FIG. 18.

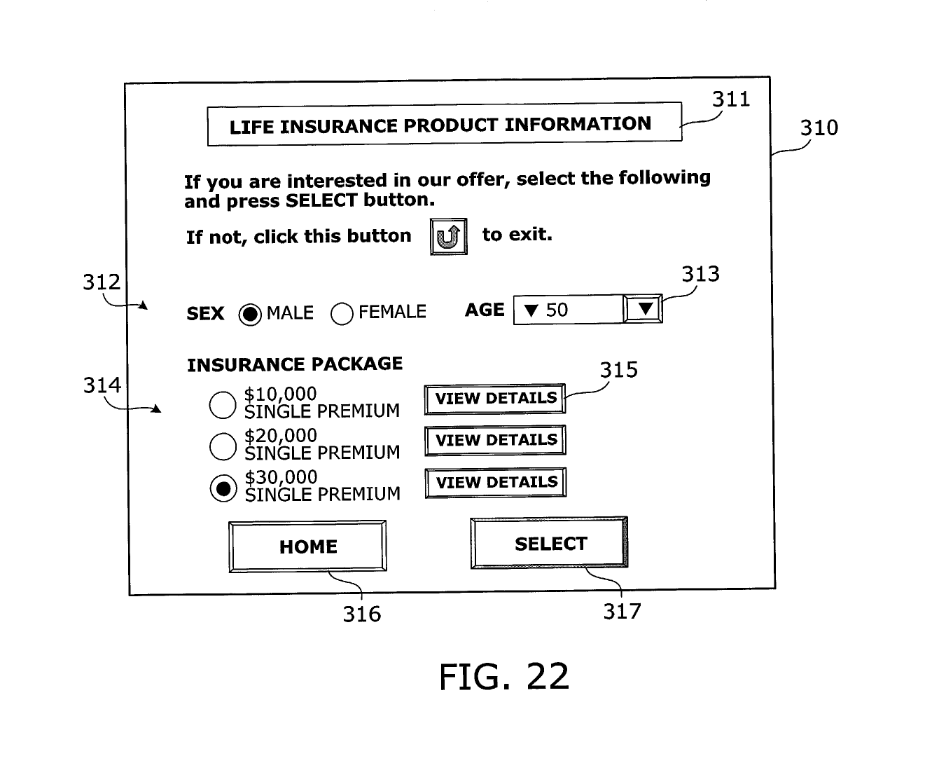

FIG. 22 shows an example of the product information page 310. This product information page 310 has a title bar 311, option boxes 312 (SEX), a list box 313 (AGE), an insurance package selection area 314, VIEW

### DETAILS buttons 315, a HOME button 316, and a SELECT button 317. The customer, or applicant, who wishes to take out life insurance is requested to fill out this page 310.

The title of the product information page 310 is shown on the title bar 311, which is “Life Insurance Service Information” in the example of FIG. 22. The applicant uses the option boxes 312 to checkmark his/her gender. The list box 313 is used to select an age range of the applicant. The list box 313 has a drop-down arrow which opens a list of age ranges. The applicant chooses one appropriate age range from the list.

The insurance package selection area 314 provides a check box for each insurance package to allow the applicant to select one of those packages. Located beside the package titles are VIEW DETAILS buttons 315. These buttons 315 are pressed when the applicant wishes to see the details of each insurance package. When one of the buttons 315 is pressed, the service delivery support system 100 sends a dedicated product information page (not shown) to the terminal 40 to provide the details of a particular insurance package.

The HOME button 316 takes the applicant back to the homepage 200 of the service site. The service delivery support system 100 sends the data of the homepage 200 (FIG. 20) to the terminal 40 when the HOME button 316 is pressed. The applicant uses the SELECT button 317 to submit the current contents of the product information page 310, thus requesting the service delivery support system 100 to proceed with an insurance contract.

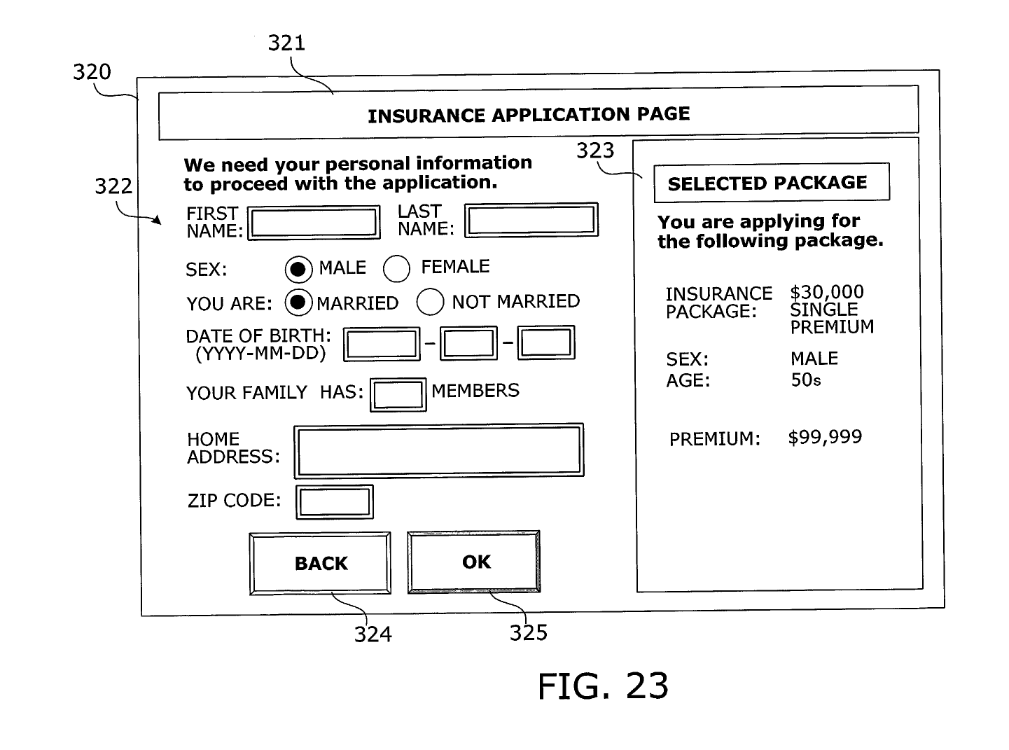

Upon depression of the SELECT button 317, a contract application page 320 appears on the screen of the terminal 40. FIG. 23 shows an example of this contract application page 320, which is composed of the following elements: a title bar 321, a personal profile entry area 322, a contract summary area 323, a BACK button 324, and an OK button 325.

The title of the contract application page 320 is shown on the title bar 321. In the example of FIG. 23, the page is entitled “Insurance Application Page.” The personal profile entry area 322 has a various fields to enter the applicant's personal information, including: first name, last name, sex, marriage status, date of birth, family members, home address, and zip code. The contract summary area 323 shows the information about the insurance contract that has been selected in the product information page 310 of FIG. 22. In the example of FIG. 23, the amount of the insurance premium and other information are shown.

The BACK button 324 is used to go back to the previous page and redo a product selection. When the applicant presses this button 324, the current information in the personal profile entry area 322 is discarded, and the terminal 40 shows the product information page 310 again.

The OK button 325, on the other hand, is used to advance the insurance application procedure with the information in the personal profile entry area 322 and contract summary area 323. When this OK button 325 is pressed, the applicant's personal information is transferred from the personal profile entry area 322 to the service delivery support system 100, together with a processing request that authorizes the application.

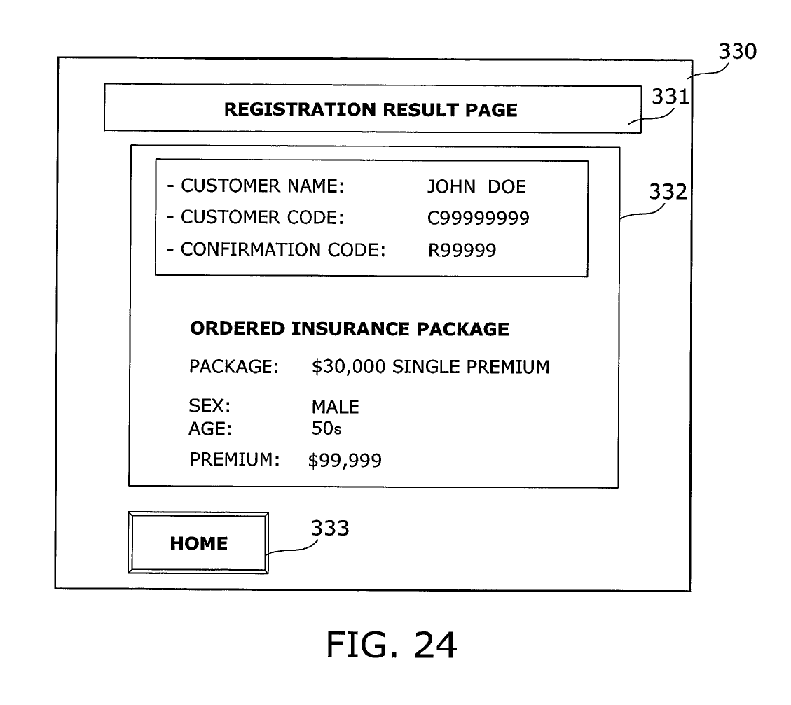

Upon depression of the OK button 325 in the contract application page 320 of FIG. 23, a registration result page 330 appears on the screen of the terminal 40. FIG. 24 shows an example of this registration result page 330, which has the following components: a title bar 331, a contract summary area 332, and a HOME button 333.

The title of the registration result page 330 is shown on the title bar 331, which is “Registration Result Page” in the example of FIG. 24. The contract summary area 332 shows the summary of the insurance application that is accepted by the service delivery support system 100. The HOME button 333 takes the applicant back to the homepage 200 of the service site. The service delivery support system 100 sends the data of the homepage 200 (FIG. 20) to the terminal 40 when this HOME button 333 is pressed.

The above section has described the member registration process. The life insurance service site provides various auxiliary programs to buyers of their insurance products. The customer sitting at the terminal 40 can purchase such an insurance product through the product information page 310 and contract application page 320. The content of the insurance contract can be checked in the registration result page 330. After the online application is completed, a packet of documents is mailed from the service site operating company to the applicant. The packet includes some formal documents that must be filled out and signed by the applicant for making a contract. Also included in the packet is a note about the bank account that should be specified as the destination when the applicant sends the insurance premium. The member ID and password are also delivered to entitle the applicant to receive online support services.

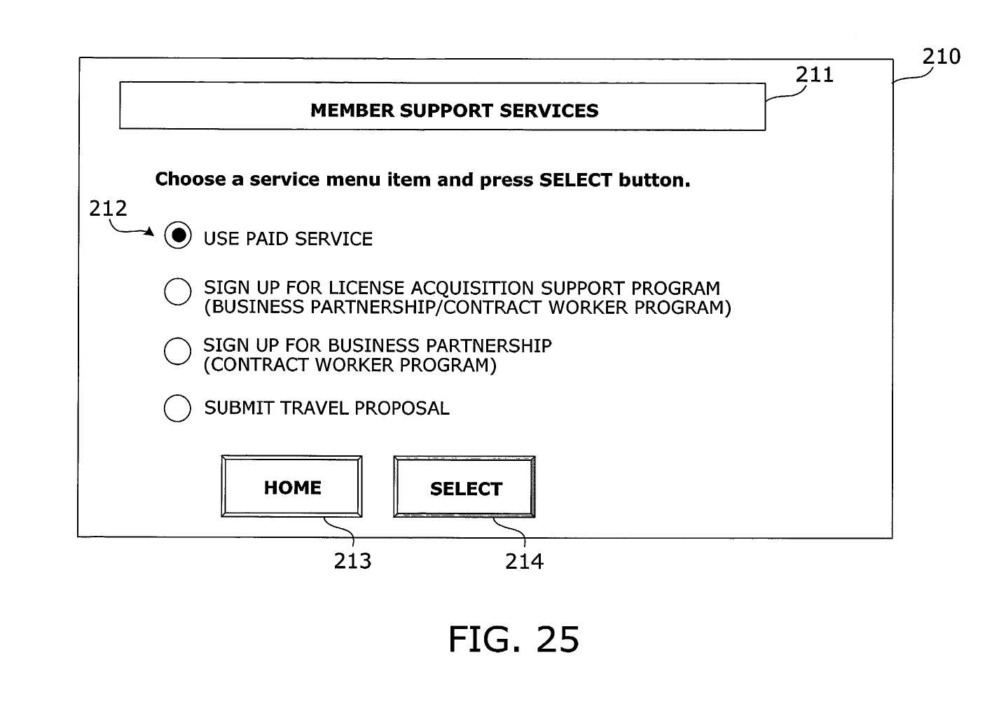

The customer fills out blank boxes in the insurance contract form, sends it back to the service site operating company, and transfers the insurance premium to the specified bank account. This process authorizes the customer as a regular member. Until the payment of the insurance premium is confirmed, the service delivery support system 100 treats the applicant as a provisional member. As a registered member, the customer is now eligible for various support services that accompany the insurance product he/she bought. To use those services, the customer first visits the service site homepage 200, making access to the service delivery support system 100 with his/her terminal 40. The customer then enters his/her member ID to the member ID field 203 in the homepage 200 (FIG. 20), as well as typing his/her password into the password entry field 204. When this OK button 205 is pressed, the entered member ID and password are transmitted to the service delivery support system 100 as authentication data of the customer. The service delivery support system 100 authenticates the customer's identity with the provided authentication data. If the authenticity is verified, the service delivery support system 100 sends a service menu page 210 to the terminal 40. FIG. 25 shows an example of this service menu page 210, which has a title bar 211, service menu check boxes 212, a HOME button 213, and a SELECT button 214.

The title of the service menu page 210 is shown on the title bar 211. In the example of FIG. 25, the page is entitled “Member Support Services.” A plurality of service menu check boxes 212 are placed in association with different services. The member can choose one of those services by putting a checkmark in the corresponding check box.

The HOME button 213 is used to return to the homepage 200 without selecting any support services. The service delivery support system 100 sends the data of the homepage 200 to the terminal 40 when this HOME button 213 is pressed. The SELECT button 214, on the other hand, is used to proceed to the selected service. When this SELECT button 214 is pressed, the terminal 40 sends a processing request to the service delivery support system 100 so as to receive the selected service. In response to this request, the service delivery support system 100 calls up a relevant service routine.

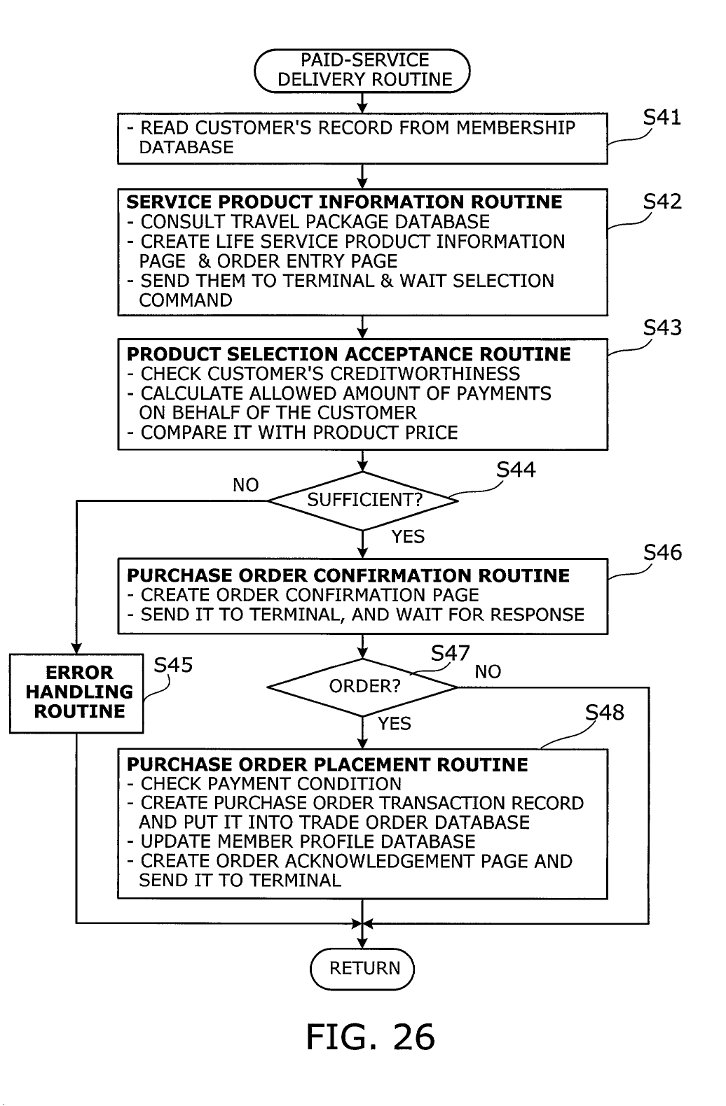

FIG. 26 is a flowchart of a paid service delivery routine, which comprises the following steps.

(S41) Consulting the member profile database 125, the paid-service processor 112 retrieves the member profile record of a particular customer who is identified by a given member ID. The paid-service processor 112 stores the retrieved member profile in its local storage, such as RAM, for later use.

(S42) paid-service processor 112 executes a service product information routine. More specifically, the paid-service processor 112 reads out travel package information from the travel package database 131, and then creates a service product information page 410 and an order entry page 420. After sending the created pages 410 and 420 to the terminal 40, the paid-service processor 112 enters an idle state, waiting for a product selection command to be returned from the terminal 40.

(S43) The customer sitting at the terminal 40 chooses a product, which enables the paid-service processor 112 to execute a product selection acceptance routine. That is, the paid-service processor 112 checks the creditworthiness of the customer, calculates how much the system would pay on behalf of the customer, and compares the price of the selected product with the allowed amount of on-behalf payments.

(S44) The paid-service processor 112 examines the result of the comparison at step S43. If the product price is higher than the allowed amount, the process advances to step S45. If the product price is within the coverage of the on-behalf payment, the process advances to step S46.

(S45) The paid-service processor 112 terminates the present routine after executing an error handling routine. The control is then returned to the calling process, thus causing the process to resume from step S15 in FIG. 18.

(S46) The paid-service processor 112 executes a purchase order confirmation routine. More specifically, the paid-service processor 112 first produces an order confirmation page 430 and sends it to the terminal 40. The paid-service processor 112 then enters an idle state, waiting for the customer to issue an order execution request through the terminal 40.

(S47) Receiving a response from the terminal 40, the paid-service processor 112 determines whether the received request is an order execution request. If so, the process advances to step S48. If not, the paid service delivery routine is terminated. The control is then returned to the calling process, thus causing the process to resume from step S15 in FIG. 18.

(S48) After checking the payment condition, the paid-service processor 112 executes a purchase order placement routine. More specifically, the paid-service processor 112 first produces a purchase order transaction record as a new entry to the trade order database 132. The paid-service processor 112 then updates the member profile database 125 accordingly. After that, it produces and sends an order acknowledgement page 440 to the terminal 40. The paid-service processor 112 now exits from the paid service support routine and thus returns the control to the calling process, allowing the processing to resume from step S15 in the flowchart of FIG. 18.

Through the above steps of the paid service delivery routine, the service site operating company pays a service fee on behalf of the customer (or member). The customer can place a purchase order for a paid service through his/her terminal 40, simply following the pages and instructions provided from the service delivery support system 100. The next section will focus on such pages used in ordering service products.

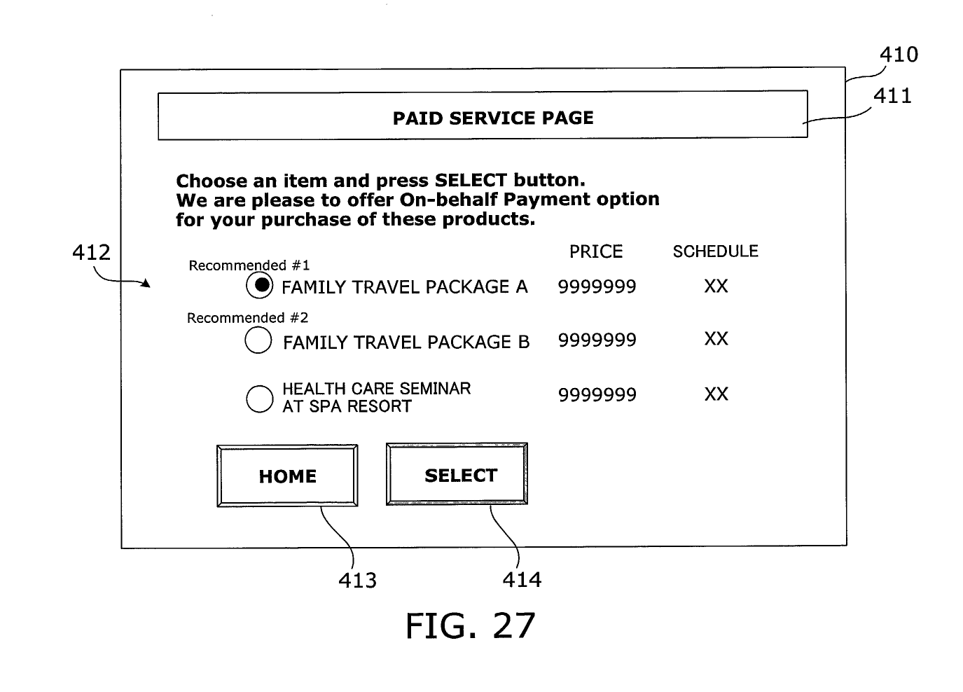

FIG. 27 shows an example of a service product information page. This service product information page 410 has a title bar 411, a sales product viewing area 412, a HOME button 413, and a SELECT button 414. The title bar 411 carries the subject of the page 410, which is “Paid Service Page” in the example of FIG. 27. The sales product viewing area 412 displays the information about service products in sale, which includes product names, sales prices, and schedule. The service site operating company may recommend some particular products. Such products are marked with a note “Recommended” as shown in FIG. 27. Each product listed in the sales product viewing area 412 has a check box to allow the customer to select his/her desired product by placing a checkmark.

The HOME button 413 is used to return to the homepage 200 without ordering paid services. The service delivery support system 100 sends the data of homepage 200 to the terminal 40 when this HOME button 413 is pressed. The SELECT button 414 allows the customer to proceed to the next page where he/she can place an order for the selected product. When the SELECT button 414 is pressed, the terminal 40 finalizes the selection of a product and requests the service delivery support system 100 to deliver an order entry page 420 for that product.

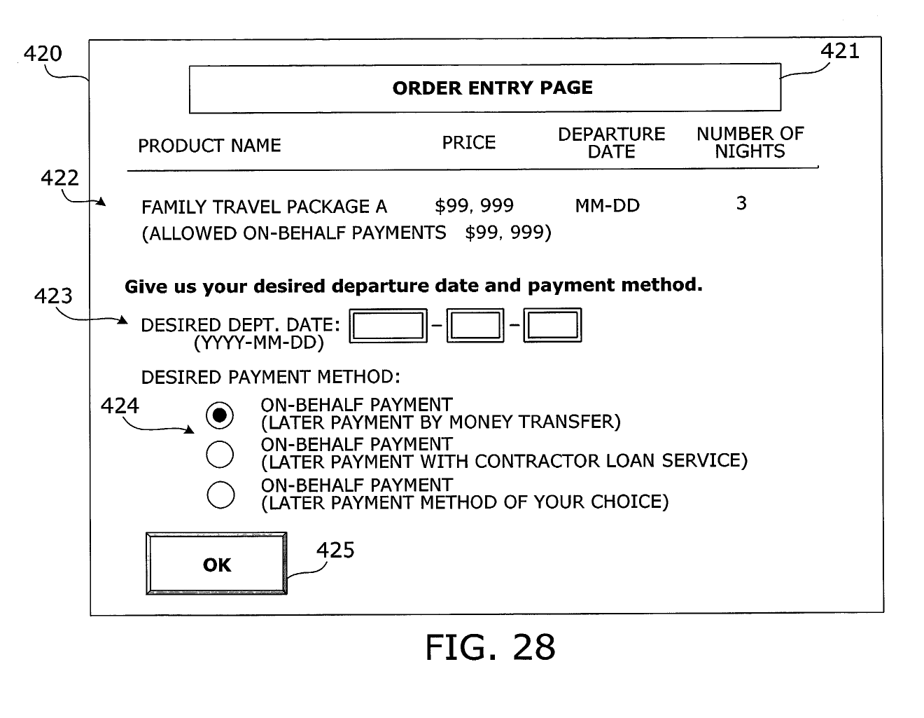

FIG. 28 shows an example of the order entry page 420, where the customer is attempting to purchase a travel package. This order entry page 420 has a title bar 421, a product description area 422, a departure date entry field 423, a payment method selection area 424, and an OK button 425. The title bar 411 carries the subject of the order entry page 420, which is “Order Entry Page” in the example of FIG. 28. The product description area 422 shows the following information regarding the selected product: product name, price, departure date, the number of nights, and the allowed amount of on-behalf payments. The departure date entry field 423 provides text boxes for the purchaser to specify a desired departure date.

The payment method selection area 424 shows payment method options. In the example of FIG. 28, the following three options are available to the purchaser: (a) on-behalf payment (later payment by money transfer); (b) on-behalf payment (later payment with contractor loan service); and (c) on-behalf payment (later payment method of your choice. Each option has a check box to enable the customer to choose one of those methods by placing a checkmark in a corresponding check box. The OK button 425 allows him/her to finalize and submit the order for the product. When this OK button 425 is pressed, the terminal 40 requests the service delivery support system 100 to proceed to the next step with the determined departure date and payment method. The service delivery support system 100 then returns an order confirmation page 430 to the terminal 40.

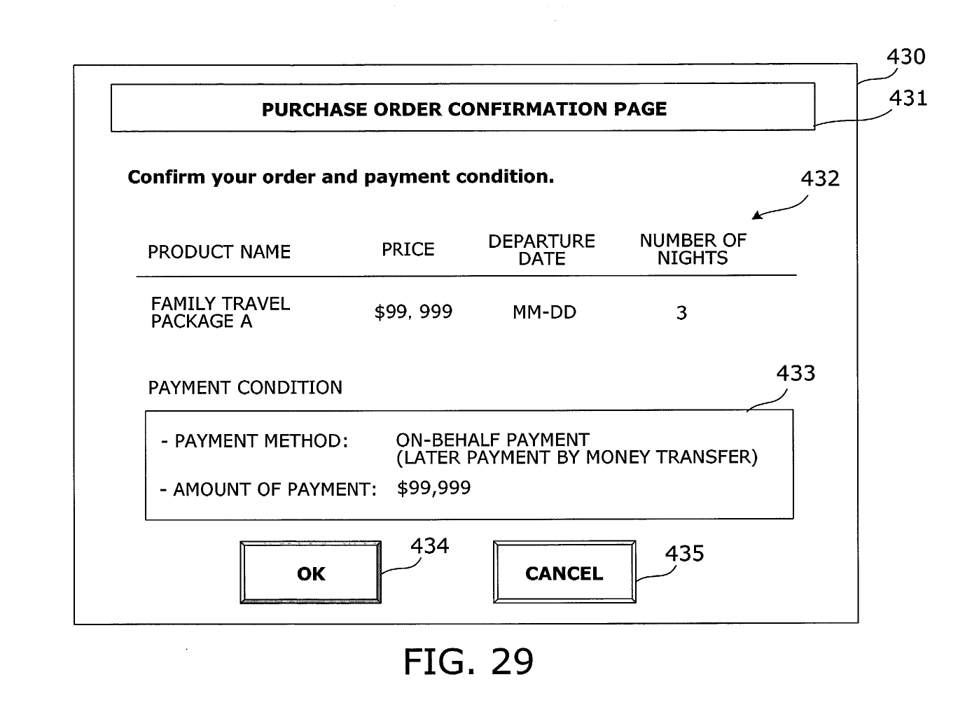

FIG. 29 shows an example of the order confirmation page 430. This order confirmation page 430 has a title bar 431, a product description area 432, a payment condition viewing area 433, an OK button 434, and a CANCEL button 435.

The subject of the order confirmation page 430 is shown on the title bar 431, which is “Purchase Order Confirmation Page” in the example of FIG. 29. The product description area 432 shows the information about the product being ordered. In the example of FIG. 29, the purchaser sees the following information in the product description area 432: product name, price, departure date, and the number of nights. Displayed in the payment condition viewing area 433 is the payment condition which will be applied to this purchase. In the example of FIG. 29, the payment method and the amount of the planned on-behalf payment are shown. The OK button 434 is used to authorize the order. When this OK button 434 is pressed, the terminal 40 requests the service delivery support system 100 to proceed with the current order contents. The CANCEL button 435, on the other hand, allows the customer to cancel the order. When this CANCEL button 435 is pressed, the current order on the order confirmation page 430 is discarded.

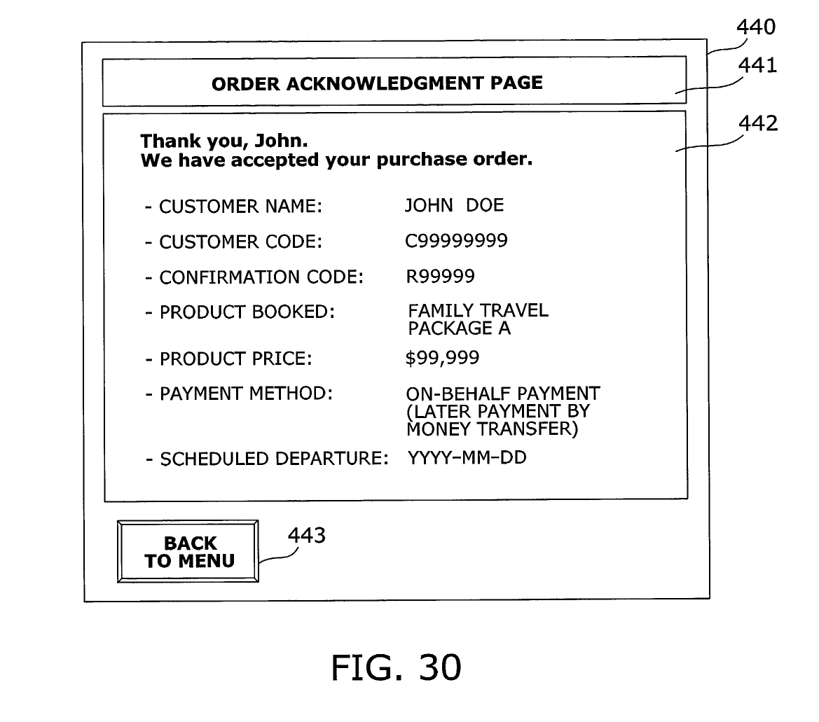

Suppose that the purchaser has pressed the OK button 434, causing an order acknowledgement page 440 to appear on the screen of his/her terminal 40. FIG. 30 shows an example of this order acknowledgement page 440, which has a title bar 441, an accepted order summary area 442, and a BACK-TO-MENU button 443. The title bar 441 carries the subject of the order acknowledgement page 440, which is “Order Acknowledgment Page” in the example of FIG. 30. The accepted order summary area 442 shows the details of the order. In the example of FIG. 30, they include the following items: customer name, customer code, confirmation code, product booked, product price, payment method, and scheduled departure date. The BACK-TO-MENU button 443, if pressed, will take the purchaser back to the service menu page 210.

The above-described process enables the customer to send an order for a paid service. Note that, at this stage, he/she may not be ready to pay for that service because the service site operating company temporarily assumes his/her debt.

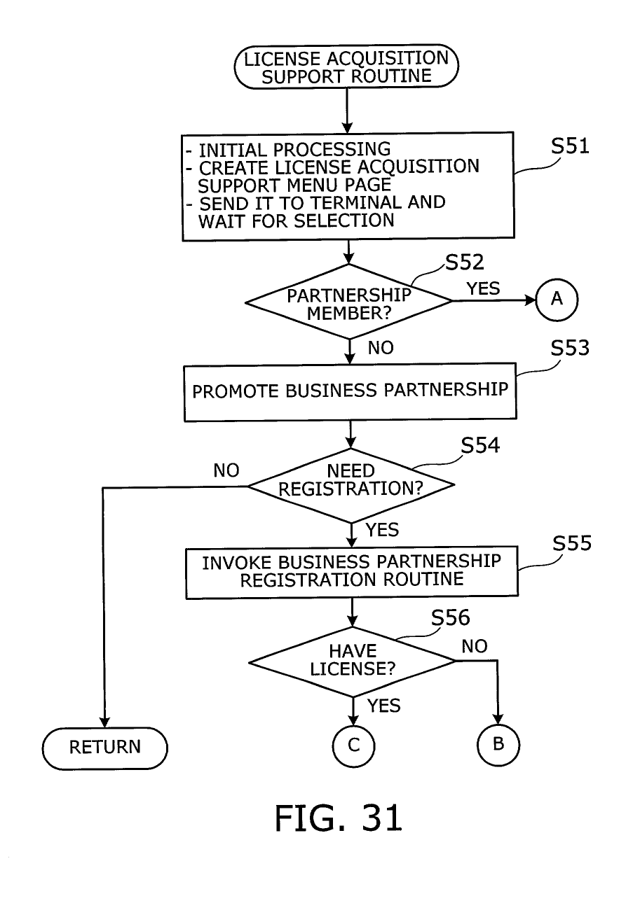

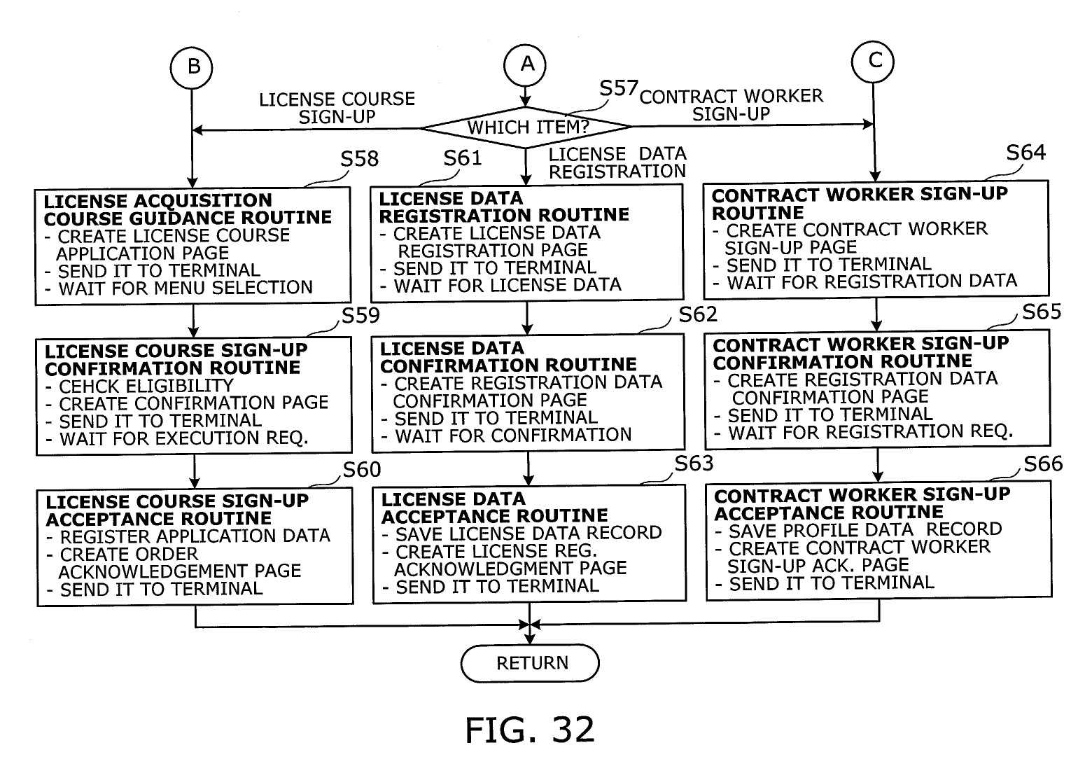

Referring next to FIGS. 31 and 32, the following section will describe the license acquisition support program. In this program, the service delivery support system 100 assists the membership to obtain a sales agent license, in response to their request sent from their terminals 40.

FIG. 31 is the first half of a flowchart of a license acquisition support routine, which comprises the following steps.

(S51) The license acquisition support processor 114 performs initial processing and then creates a license acquisition support menu page. After sending the page to the terminal 40, the license acquisition support processor 114 enters to an idle state, waiting for the customer to select a menu item.

(S52) When the customer's selection is received from the terminal 40, the license acquisition support processor 114 determines whether the customer is a business partnership member. If so, the process advances to step S57 (see FIG. 32). If not, the process proceeds to step S53.

(S53) The license acquisition support processor 114 promotes the business partnership program. (S54) Receiving a response from the terminal 40, the license acquisition support processor 114 determines whether the customer wishes to become a business partnership member. If so, the process advances to step S55. If not, the license acquisition support processor 114 exits from the license acquisition support routine, thus returning the control to the calling process. Accordingly, the process resumes from step S15 of FIG. 18.

(S55) The license acquisition support processor 114 invokes a business partnership registration routine.

(S56) Receiving a response from the terminal 40, the license acquisition support processor 114 determines whether the customer has any license. If he/she has a license, the process advances to step S64 (FIG. 32). If not, the process proceeds to step S58 (FIG. 32).

FIG. 32 is the second half of the flowchart, which comprises the following steps.

(S57) The license acquisition support processor 114 determines which menu item was selected in the license acquisition support menu page. If it was “License Course Sign-up,” then the process advances to step S58. If it was “License Data Registration,” then the process advances to step S61. If it was “Contract Worker Sign-up,” then the process advances to step S64.

(S58) The license acquisition support processor 114 executes a license acquisition course guidance routine. More specifically, the license acquisition support processor 114 creates a license acquisition course application page and sends it to the terminal 40. The license acquisition support processor 114 then enters to an idle state, waiting for the customer to select a menu item on his/her terminal 40.

(S59) The customer signs up in the license acquisition course application page, and the terminal 40 sends the information of the application to the service delivery support system 100. With this information, the license acquisition support processor 114 executes a license course sign-up confirmation routine. Specifically, the license acquisition support processor 114 first checks whether the customer is eligible for the application. The license acquisition support processor 114 then creates a license course confirmation page and sends it to the terminal 40. The license acquisition support processor 114 enters to an idle state, waiting for an execution request to be returned from the terminal 40.

(S60) Upon receipt of the execution request sent from the terminal 40, the license acquisition support processor 114 executes a license course sign-up acceptance routine. More specifically, the license acquisition support processor 114 registers the order and then creates an order acknowledgement page. After sending the created page to the terminal 40, the license acquisition support processor 114 exits from the present routine, thus returning the process to step S15 in the flowchart of FIG. 18.

(S61) The license acquisition support processor 114 executes a license data registration routine. More specifically, the license acquisition support processor 114 first produces a license data registration page and sends it to the terminal 40. The license acquisition support processor 114 then enters to an idle state, waiting for registration data to be supplied from the terminal 40.

(S62) When the customer's license registration data is received from the terminal 40, the license acquisition support processor 114 executes a license data confirmation routine. More specifically, the license acquisition support processor 114 produces a registration data confirmation page and sends it to the terminal 40. The license acquisition support processor 114 then enters to an idle state, waiting for the customer to confirm the data.

(S63) Upon receipt of the confirmation, the license acquisition support processor 114 executes a license data acceptance routine. More specifically, the license acquisition support processor 114 begins with saving the license data record into a relevant database. The license acquisition support processor 114 then produces a license registration acknowledgment page. After sending the created page to the terminal 40, the license acquisition support processor 114 exits from the present routine, thus resuming the process from step S15 in the flowchart of FIG. 18.

(S64) The license acquisition support processor 114 executes a contract worker sign-up routine. More specifically, the license acquisition support processor 114 creates a contract worker sign-up page and sends it to the terminal 40. The license acquisition support processor 114 then enters to an idle state, waiting for the registration data to be supplied from the applicant.

(S65) Upon receipt of the registration data, the license acquisition support processor 114 executes a contract worker sign-up confirmation routine. More specifically, the license acquisition support processor 114 creates a registration data confirmation page and sends it to the terminal 40. After that, the license acquisition support processor 114 enters an idle state, waiting for a registration execution request.

(S66) Upon receipt of a registration execution request, the license acquisition support processor 114 executes a contract worker sign-up acceptance routine. More specifically, the license acquisition support processor 114 begins with saving the customer's profile record into a relevant database. Then it creates a contract worker sign-up acknowledgment page for delivery to the terminal 40. After that, the license acquisition support processor 114 exits from the present routine, thus resuming the process from step S15 in the flowchart of FIG. 18.

Through the above-described license acquisition support routine, the service delivery support system 100 gives to the membership an opportunity to obtain a license. During this process, the service delivery support system 100 creates and delivers various pages for display on the terminal 40. The customer can sign up for a desired license course by simply following the instructions provided in each page. The next section will focus on such pages used in license acquisition support services.

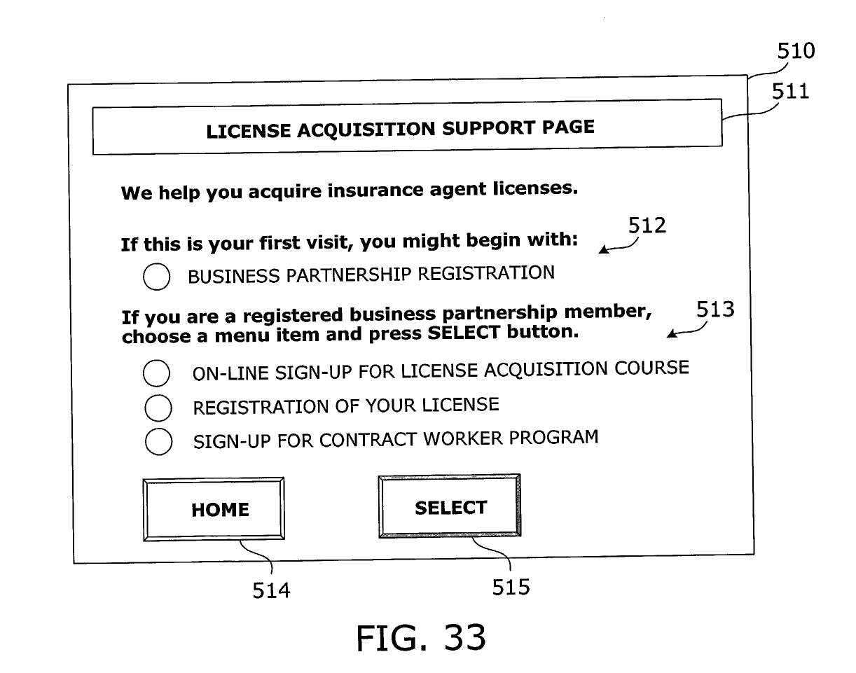

FIG. 33 shows an example of a license acquisition support menu page. This license acquisition support menu page 510 has the following components: a title bar 511, a non-member service menu area 512, a member service menu area 513, a HOME button 514, and a SELECT button 515. The title bar 511 shows the subject of the license acquisition support menu page 510, which is “License Acquisition Support Page” in the example of FIG. 33. The non-member service menu area 512 is prepared for those who have not registered themselves as business partnership members. A check box for business partnership registration is provided in this area 512, allowing the customer to select that option by placing a checkmark in the check box.

The member service menu area 513, on the other hand, provides a service menu for the registered business partnership members. Listed in this area 513 are: (a) online sign-up for license acquisition course, (b) registration of a member's license data, and (c) sign-up for contract worker program. Each of those menu items has a check box for selection.

The HOME button 514 is used to return to the homepage 200 without selecting any support services. The service delivery support system 100 sends the data of homepage 200 to the terminal 40 when this HOME button 514 is pressed. The SELECT button 515 is used to notify the service delivery support system 100 of which item the customer has selected from among those in the non-member service menu area 512 or member service menu area 513. When this button 515 is pressed, the service delivery support system 100 supplies an appropriate page to the terminal 40, depending on the selected menu item. Suppose, for example, that the check box in the non-member service menu area 512 is selected. In this case, the terminal 40 displays a business partnership registration page 520a.

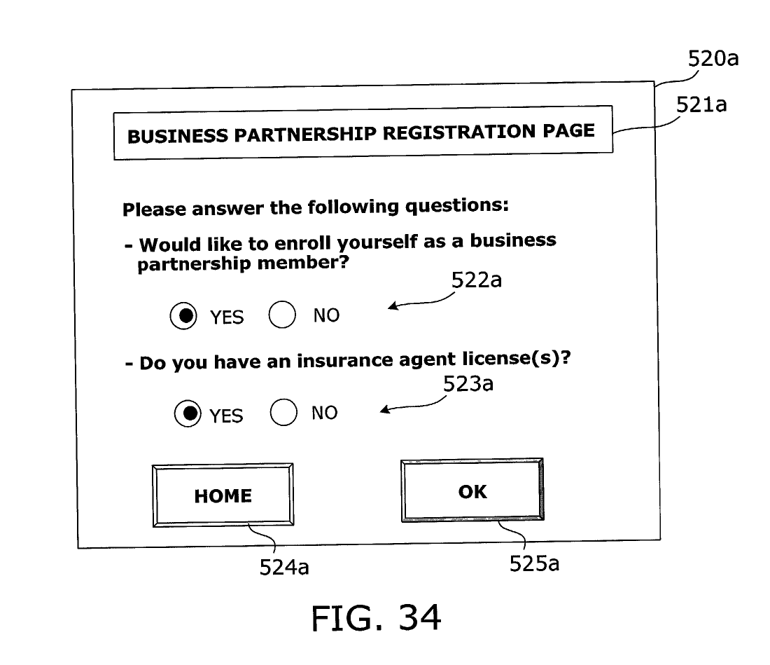

FIG. 34 shows an example of a business partnership registration page. This page 520a has the following components: a title bar 521a, a first set of check boxes 522a, a second set of check boxes 523a, a HOME button 524a, and an OK button 525a.

The title bar 521a indicates the subject of the business partnership registration page 520a, which is “Business Partnership Registration Page” in the example of FIG. 34. The first set of check boxes 522a, labeled “YES” and “NO,” allow the customer to indicate his/her willingness to participate in the business partnership program. That is, if the customer wishes to be a business partnership member, he/she selects “YES.” Otherwise, he/she selects “NO.”

The second set of check boxes are also labeled “YES” and “NO” to allow the customer to indicate whether he/she has any license to declare. If the customer is, for example, an accredited insurance agent, he/she might select “YES.” Customers having no such licenses are supposed to select “NO.”

The HOME button 524a is used to return to the homepage 200 without executing partnership registration. The service delivery support system 100 sends the data of homepage 200 to the terminal 40 when this HOME button 524a is pressed. The OK button 525a, on the other hand, is used to request a business partnership registration procedure. When this OK button 525a is pressed, the terminal 40 informs the service delivery support system 100 of the customer's request, thus invoking a business partnership sign-up routine.

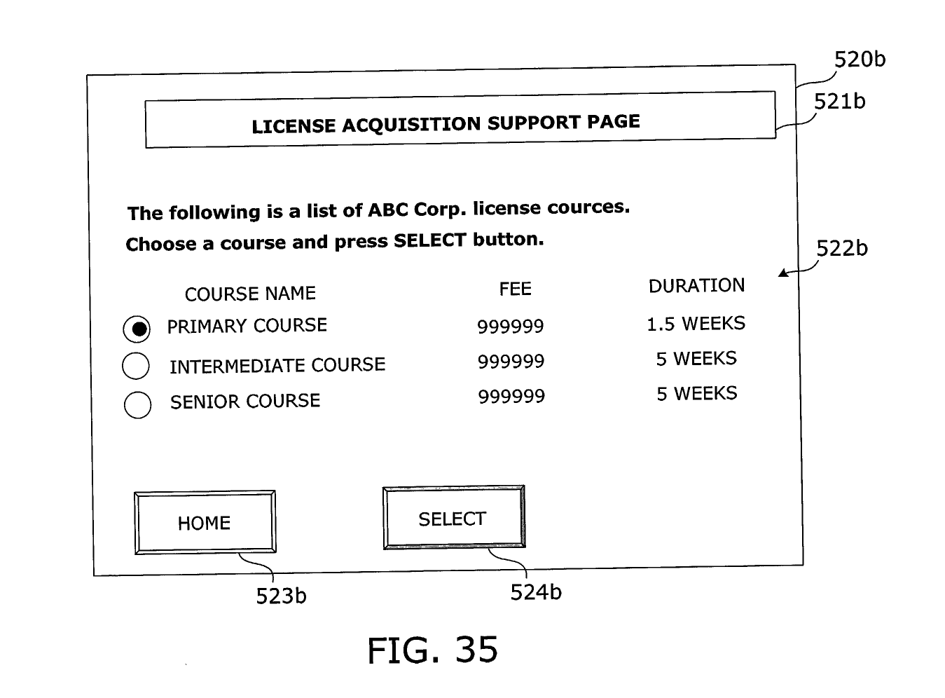

Suppose here that the customer has selected “YES” for the business partnership and “NO” for the license status. When the OK button 525a is pressed in this context, a license acquisition course application page will then be displayed on the screen of the terminal 40. FIG. 35 shows an example of this license acquisition course application page 520b, which has a title bar 521b, a course selection area 522b, a HOME button 523b, and a SELECT button 524b.

The title bar 521b indicates the subject of the license acquisition course application page 520b, which is “License Acquisition Support Page” in the example of FIG. 35. The course selection area 522b is used to list a variety of courses available to the customer. In the example of FIG. 35, there are three courses: “Primary Course,” “Intermediate Course,” and “Senior Course.” Each course option has a check box, which facilitates the customer to select one of the available courses.

The HOME button 523b is used to return to the homepage 200 without selecting any license course. The service delivery support system 100 sends the data of homepage 200 to the terminal 40 if this HOME button 523b is pressed. The SELECT button 524b, on the other hand, is used to proceed to the sign-up for a desired license course. When this SELECT button 524b is pressed, the terminal 40 sends the current selection to the service delivery support system 100, thus invoking a license course sign-up procedure.

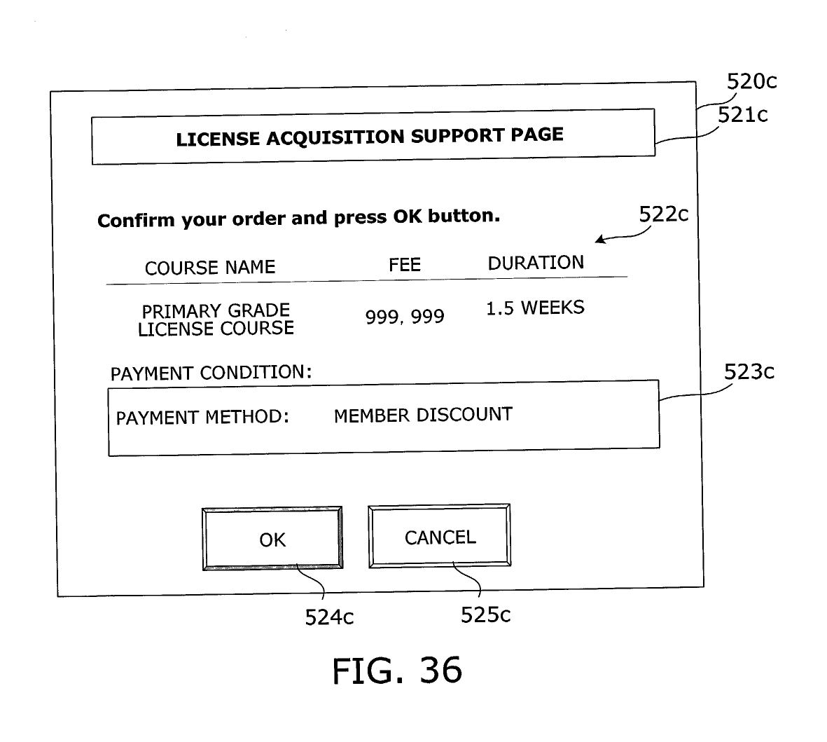

Now that the customer has selected a license course, the service delivery support system 100 sends an order confirmation page to the terminal 40. FIG. 36 shows an example of such an order confirmation page. This order confirmation page 520c has a title bar 521c, a course description area 522c, a payment condition viewing area 523c, an OK button 524c, and a CANCEL button 525c.

The title bar 521c shows the subject of the order confirmation page 520c, which is “License Acquisition Support Page” in the example of FIG. 36. The description of the selected course is shown in the course description area 522c. In the example of FIG. 36, it give the name, fee, and duration of the selected course. The payment condition viewing area 523c displays the payment conditions for the course.

The OK button 524c is used to authorize the application for the course with the current order contents shown in the order confirmation page 520c. When this OK button 524c is pressed, the current application data is transmitted from the terminal 40 to the service delivery support system 100. The CANCEL button 525c, on the other hand, is used when the customer leaves this page 520c without sending the application data, because, for example, he/she needs to change the course selection. When the CANCEL button 525c is pressed, the customer will be taken to some other page (e.g., license acquisition course application page 520b), canceling the confirmation of the order.

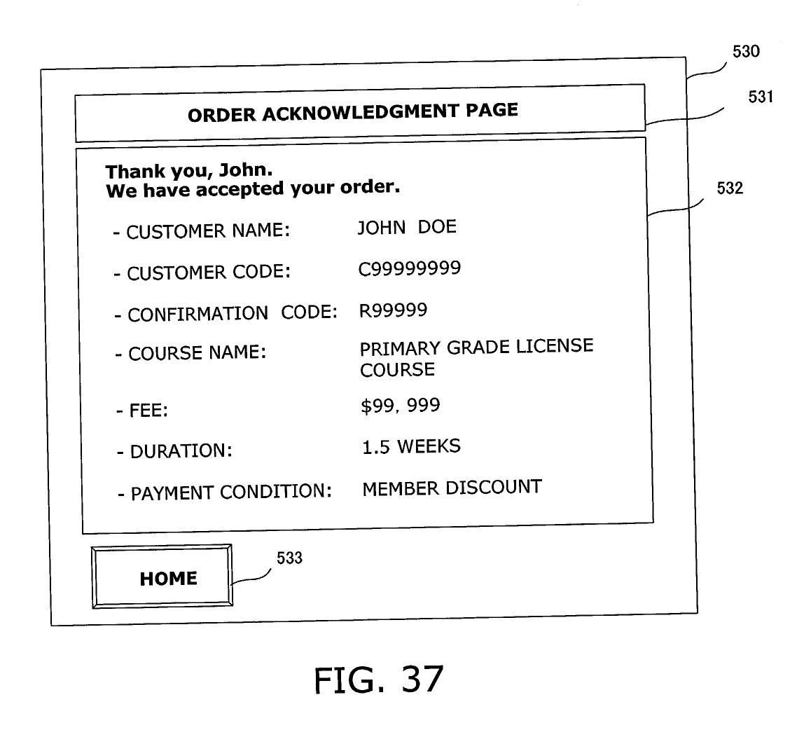

Consider here that the customer has confirmed the order by pressing the OK button 524c. The service delivery support system 100 then delivers an order acknowledgement page to the terminal 40. FIG. 37 shows an example of this order acknowledgement page 530, which has a title bar 531, an order viewing area 532, and a HOME button 533.

The title bar 531 carries the subject of the order acknowledgement page 530, which is “Order Acknowledgment Page” in the example of FIG. 37. The specifics of the order are displayed in the order viewing area 532. In the example of FIG. 37, they include the following items: customer name, customer code, confirmation code, course name, fee, duration, and payment condition. The customer is supposed to press the HOME button 533 when he/she has finished with the order acknowledgement page 530. When the HOME button 533 is pressed, the homepage 200 is displayed on the screen of the terminal 40.

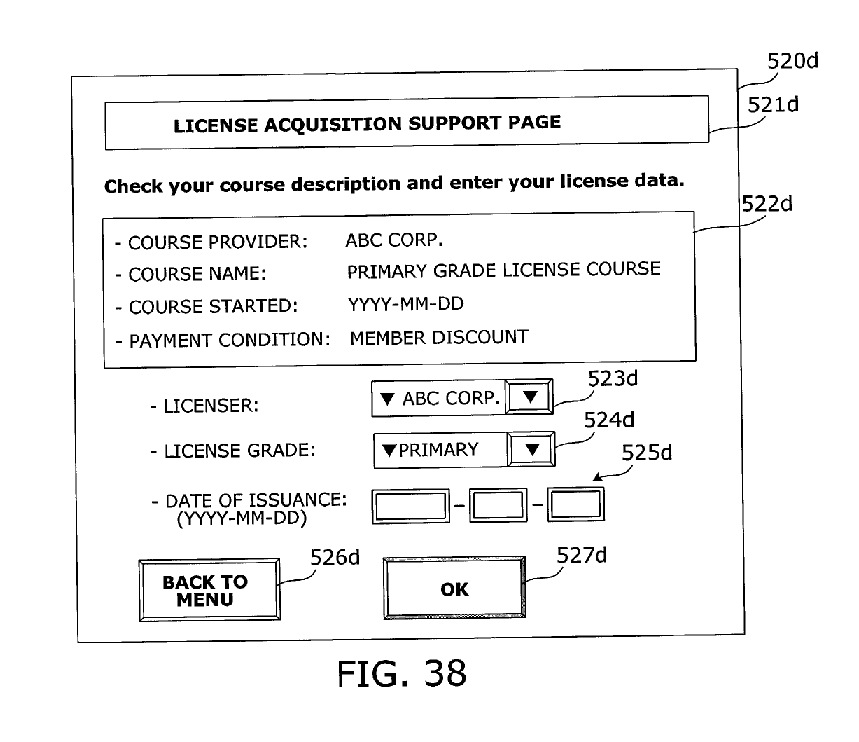

Referring now to FIGS. 38 to 40, the next section will describes the pages to be displayed on the terminal 40 in the license data registration routine. It is assumed here that the customer has selected “Registration of Your License” in the member service menu area 513 on the license acquisition support menu page 510 of FIG. 33. If the customer presses the SELECT button 515 in this context, the service delivery support system 100 delivers a license data registration page to the terminal 40 (which is not shown in the screen transition diagram of FIG. 19).

FIG. 38 shows an example of a license data registration page. This license data registration page 520d has a title bar 521d, a course specifics viewing area 522d, a licenser name list box 523d, a license grade list box 524d, an issuance date entry area 525d, a BACK-TO-MENU button 526d, and an OK button 527d.

The title bar 521d shows the subject of the license data registration page 520d, which is “License Acquisition Support Page” in the example of FIG. 38. The course specifics viewing area 522d shows the specifics of a license course which the registered customer has been attending. The licenser name list box 523d is used to specify the name of a company (e.g., a damage insurance company) that has accredited the customer as their agent. This list box 523d has a drop-down arrow for viewing a list of organizations in partnership with the service site operating company. The customer can find and specify his/her licensor company from among those in the drop-down list. The license grade list box 524d is used to specify what grade of license the customer obtained. This list box 523d also has a drop-down arrow for viewing a list of possible grades, so that the customer can find and specify his/her grade from among those in the drop-down list. The issuance date entry area 525d provides a series of text boxes to specify the date when the license was actually issued.

The BACK-TO-MENU button 526d is used to return to the license acquisition support menu page 510 without making a license data registration. Depression of this button 526d causes the license acquisition support menu page 510 (FIG. 33) to appear on the terminal 40. The OK button 527d, on the other hand, is used to execute the registration with what are specified in the license data registration page 520d. That is, the terminal 40 transfers the current contents of the licenser name list box 523d, license grade list box 524d, and issuance date entry area 525d to the service delivery support system 100 when the OK button 527d is pressed.

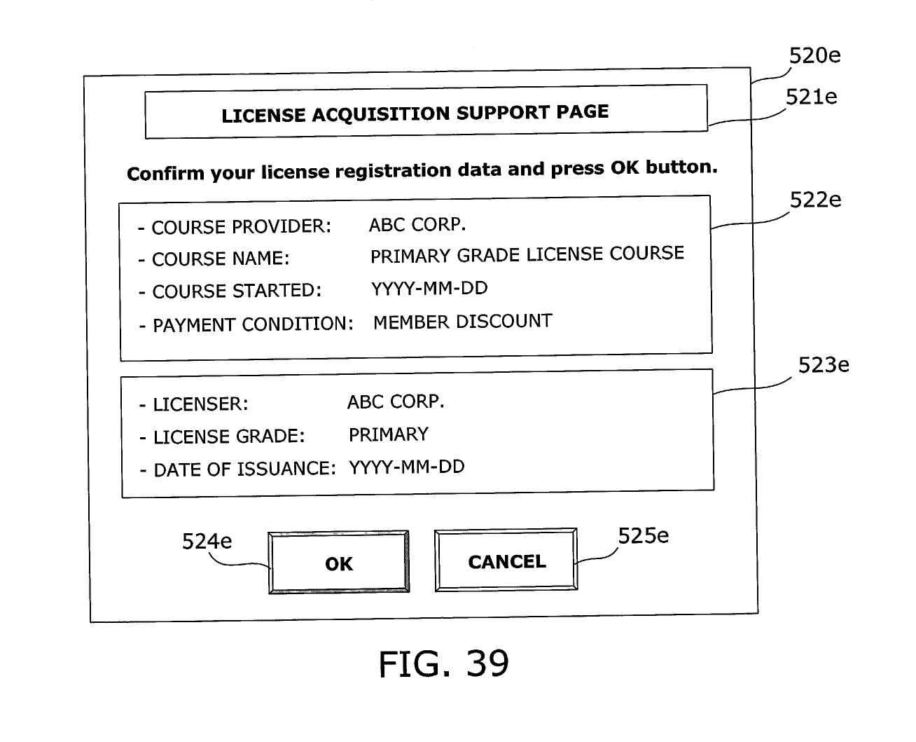

Triggered by the above action of the OK button 527d, the service delivery support system 100 returns a license registration confirmation page to the terminal 40. FIG. 39 shows an example of this license registration confirmation page. The license data confirmation page 520e has a title bar 521e, a course specifics viewing area 522e, a license specifics viewing area 523e, an OK button 524e, and a CANCEL button 525e.

The title bar 521e shows the subject of the license data confirmation page 520e, “License Acquisition Support Page” in the example of FIG. 39. The course specifics viewing area 522e shows the specifics of the course which customer attended. Shown in the license specifics viewing area 523e is the license data which the customer has entered in the previous page, i.e., license data registration page 520d. The OK button 524e is used to indicate the confirmation of the license data shown in the license specifics viewing area 523e and thus permit its registration. When this OK button 524e is pressed, the terminal 40 informs the service delivery support system 100 of the confirmation. The CANCEL button 525e, on the other hand, allows the customer to cancel the license data registration. When this CANCEL button 525e is pressed, a registration cancel command is transmitted to the service delivery support system 100.

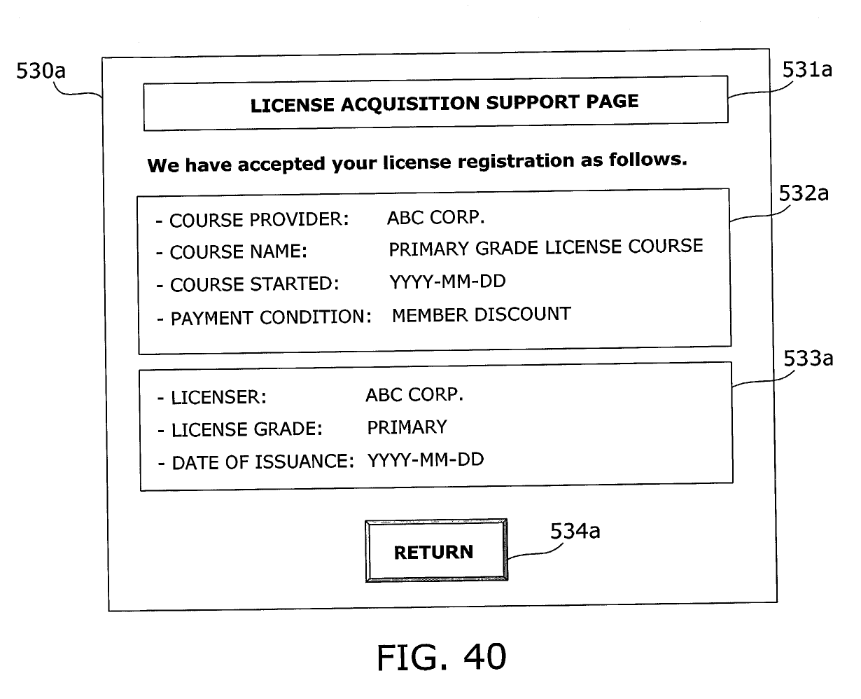

Suppose here that the customer has presses the OK button 524e. This operation takes him/her to a license registration acknowledgment page. FIG. 40 shows an example of this license registration acknowledgment page. The license registration acknowledgment page 530a has a title bar 531a, a course specifics viewing area 532a, a license specifics viewing area 533a, and a RETURN button 534a.

The title bar 531a shows the subject of the license registration acknowledgment page 530a, “License Acquisition Support Page” in the example of FIG. 40. The course specifics viewing area 532a shows the specifics of the course which customer attended. Shown in the license specifics viewing area 533a is the license data which the customer has entered in the license data registration page 520d. The customer is supposed to press the RETURN button 534a when he/she has finished with the license registration acknowledgment page 530a. When this RETURN button 534a is pressed, the service delivery support system 100 provides the terminal 40 with an upper-layer page, such as the license acquisition support menu page 510 shown in FIG. 33.

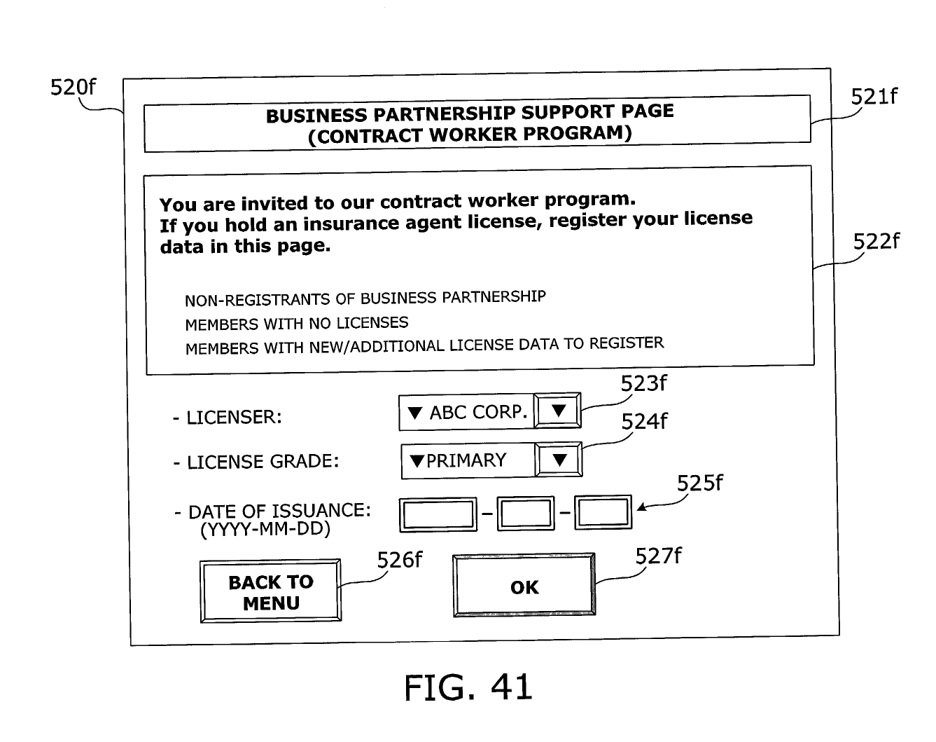

Referring now to FIGS. 41 to 43, the next section will describes the pages to be displayed on the terminal 40 in the contract worker sign-up routine. It is assumed here that the customer has selected “Sign-up for Contract Worker Program” in the member service menu area 513 of the license acquisition support menu page 510 of FIG. 33. If the customer presses the SELECT button 515 in this context, the service delivery support system 100 delivers a contract worker sign-up page 520f to the terminal 40 FIG. 41 shows an example of this contract worker sign-up page 520f. The contract worker sign-up page 520f has the following components: a title bar 521f, a contract worker sign-up information area 522f, a licenser name list box 523f, a license grade list box 524f, an issuance date entry area 525f, a BACK-TO-MENU button 526f, and an OK button 527d.

The title bar 521f shows the subject of the contract worker sign-up page 520f, which is “Business Partnership Support Page (Contract Worker Program)” in the example of FIG. 41. The contract worker sign-up information area 522f shows a message to encourage the customer to join the contract worker program. The licenser name list box 523f is used to specify the name of a company (e.g., a damage insurance company) that has accredited the customer as their agent. This list box 523f has a drop-down arrow for viewing a list of organizations in partnership with the service site operating company. The customer can find and specify his/her licensor company from among those in the drop-down list.

The license grade list box 524f is used to specify the grade of the license that the customer owns. This list box 524f has a drop-down arrow for viewing a list of possible grades, so that the customer can find and specify his/her grade from among those in the drop-down list. In the issuance date entry area 525f, there are a series of text boxes for the customer to enter the date when his/her license was actually issued.

The BACK-TO-MENU button 526f is used to return to the license acquisition support menu page 510 without making a contract worker registration. When this button 526f is pressed, the license acquisition support menu page 510 (FIG. 33) appears on the terminal 40. The OK button 527f, on the other hand, is used to execute the registration with what are specified in the contract worker sign-up page 520f. That is, the terminal 40 transfers the current contents of the licenser name list box 523f, license grade list box 524f, and issuance date entry area 525f to the service delivery support system 100 in response to a click on the OK button 527f.

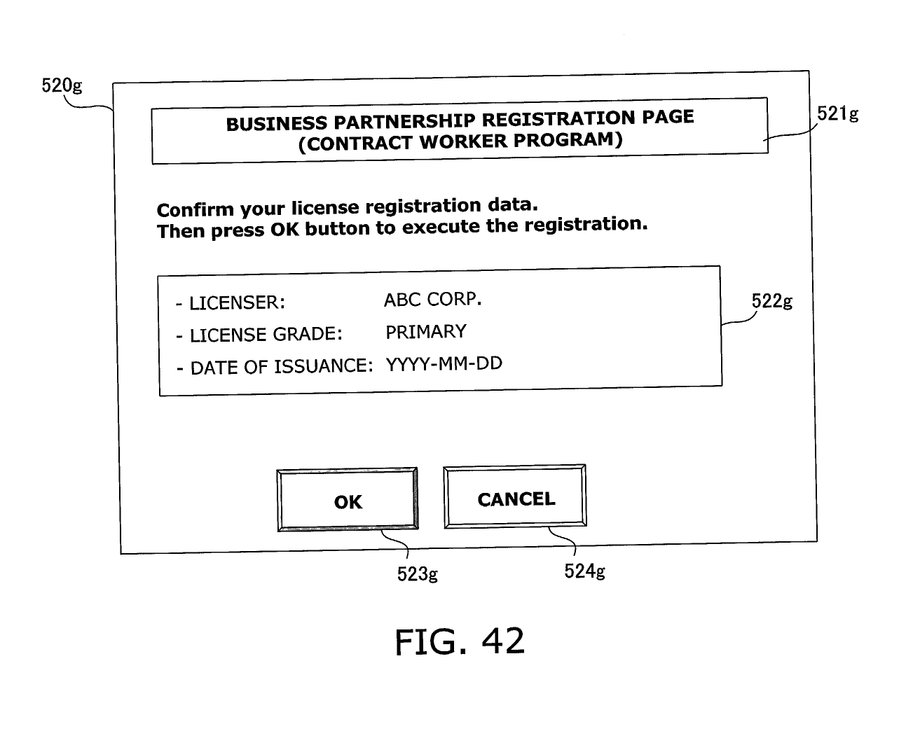

Triggered by the above action of the OK button 527f, the service delivery support system 100 returns a contract worker record confirmation page 520g to the terminal 40. FIG. 42 shows an example of this contract worker record confirmation page 520g, which has a title bar 521g, a license record viewing field 522g, an OK button 523g, and a CANCEL button 524g.

The title bar 521g shows the subject of the contract worker record confirmation page 520g, which is “Business Partnership Registration Page (Contract Worker Program)” in the example of FIG. 42. The license specifics viewing area 533a shows the license data which the customer has entered in the contract worker sign-up page 520f. The customer uses the OK button 523g to permit the contract worker registration with the license data shown in the contract worker record confirmation page 520g. When this OK button 523g is pressed, the terminal 40 informs the service delivery support system 100 of the permission. The CANCEL button 524g, on the other hand, is used to cancel the registration. When the customer operated this CANCEL button 524g, a registration cancellation command would be transmitted to the service delivery support system 100, causing the screen of the terminal 40 to change to an upper-layer page, such as the license acquisition support menu page 510 shown in FIG. 33.

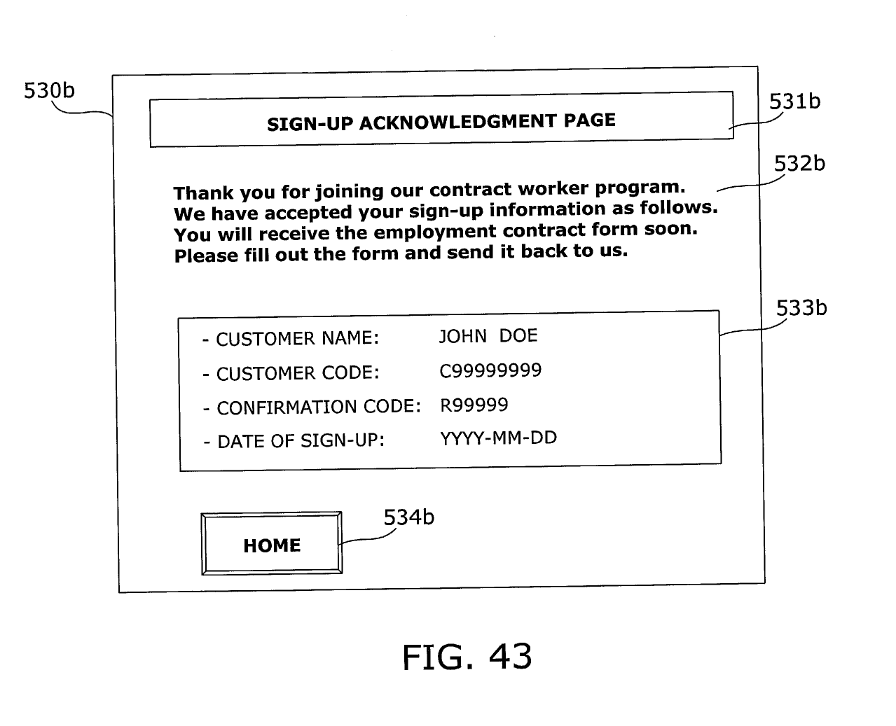

Suppose that the customer has pressed the OK button 523g. This operation then takes him/her to a contract worker sign-up acknowledgment page 530b. FIG. 43 shows an example of this contract worker sign-up acknowledgment page 530b, which has a title bar 531b, a comment area 532b, a contract summary area 533b, and a HOME button 534b. The title bar 531b shows the subject of the contract worker sign-up acknowledgment page 530b, which is “Sign-up Acknowledgment Page” in the example of FIG. 43. The comment area 532b shows a message requesting the customer to mail the application form. The contract summary area 533b gives the specifics of the contract, which include the customer name, customer code, confirmation code, and the date of acceptance, in the example of FIG. 43. After confirming the content of the contract worker sign-up acknowledgment page 530b, the customer presses the HOME button 534b to return to the homepage 200.

The above-described process allows members to contract with the service site operating company for business partnership, if they have an insurance agent license. While not eligible for the contract worker program, members without licenses can make on-line registration for job training courses through their terminals 40. When applying for a course, they can ask the service site operating company to pay the course fee on behalf of them if necessary. The proposed system delivers support services to the membership, thus helping them enrich their lives.

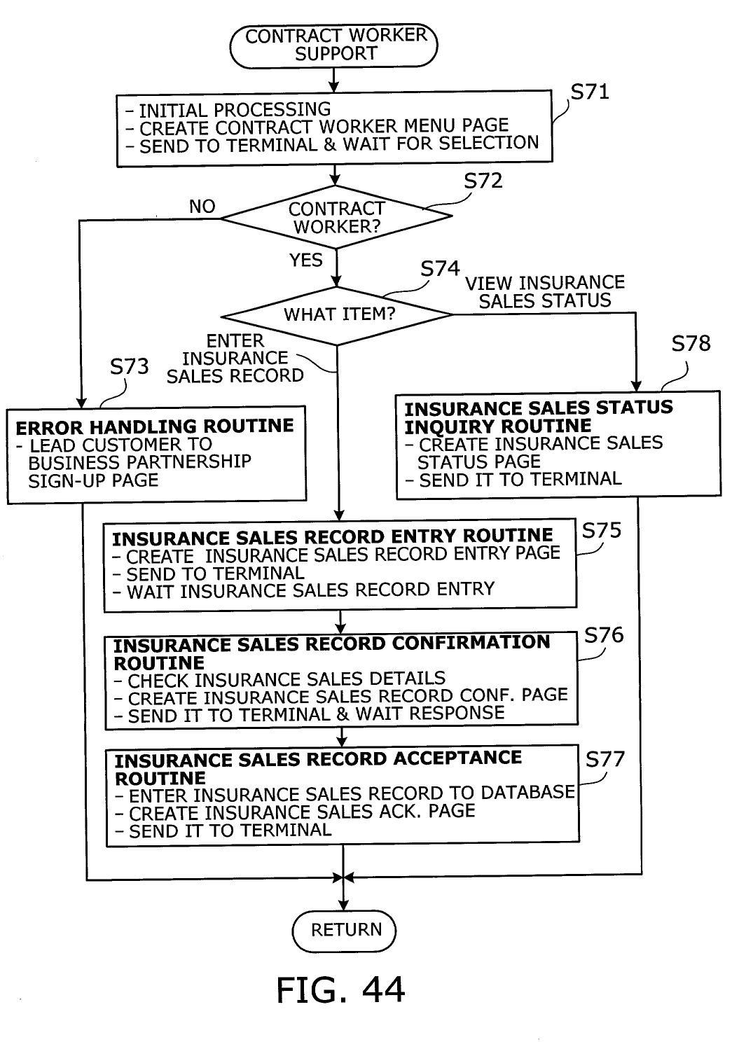

Referring next to FIGS. 44 to 49, the next section will describe the license acquisition support routine. FIG. 44 is a general flowchart of this routine, which comprises the following steps.

(S71) The contract worker support processor 113 starts with initial processing. It then creates a contract worker menu page and sends the page to the terminal 40. After that, the contract worker support processor 113 enters an idle state, waiting for the customer to select a menu item.

(S72) The terminal 40 informs the service delivery support system 100 of the selected item. Upon receipt of the information, the contract worker support processor 113 determines whether the customer is a registered contract worker. If so, the process advances to step S74. If not, the customer is not eligible for the services of the present routine, and accordingly, the process proceeds to step S73.

(S73) The contract worker support processor 113 handles the eligibility error. More specifically, the customer is lead to the business partnership sign-up page. The contract worker support processor 113 exits from the present routine of FIG. 44, returning the control to the calling process. As a result, the process resumes from step S15 in the flowchart of FIG. 18.

(S74) Depending on which menu item was selected, the contract worker support processor 113 branches to an appropriate step. If it is “Enter Insurance Sales Record,” then the process advances to step S75. If it is “View Insurance Sales Status,” then the process advances to step S78.

(S75) The contract worker support processor 113 executes an insurance sales record entry routine. More specifically, the contract worker support processor 113 creates an insurance sales record entry page and sends it to the terminal 40. After that, the contract worker support processor 113 enters to an idle state, waiting for an insurance sales record to be sent from the terminal 40.

(S76) The contract worker support processor 113 executes an insurance sales record confirmation routine. More specifically, the contract worker support processor 113 confirms the consistency of the received sales record by checking each given data item. It then creates an insurance sales record entry page and sends the page to the terminal 40. After that, the contract worker support processor 113 enters to an idle state, waiting for a response from the terminal 40.

(S77) The contract worker support processor 113 executes an insurance sales record acceptance routine. More specifically, the contract worker support processor 113 first enters the record to a relevant database. It then creates an insurance sales acknowledgment page for delivery to the terminal 40. After that, the contract worker support processor 113 exits from the present routine, thus resuming the process from step S15 in the flowchart of FIG. 18.

(S78) The contract worker support processor 113 executes an insurance sales status inquiry routine. More specifically, the contract worker support processor 113 cerates and sends an insurance sales status page, thus providing the terminal 40 with the sales track record of the customer, as well as the progress of new insurance contracts. After that, the contract worker support processor 113 exits from the present routine, thus resuming the process from step S15 in the flowchart of FIG. 18.

In this way, the service delivery support system 100 helps the contract workers to enter their sales records to the system's database. As mentioned in the above description of the flowchart, the customer accomplishes the task of sales record entry by simply following instructions in the pages sent from the service delivery support system 100. The next section will focus on such pages used in contract worker support services.

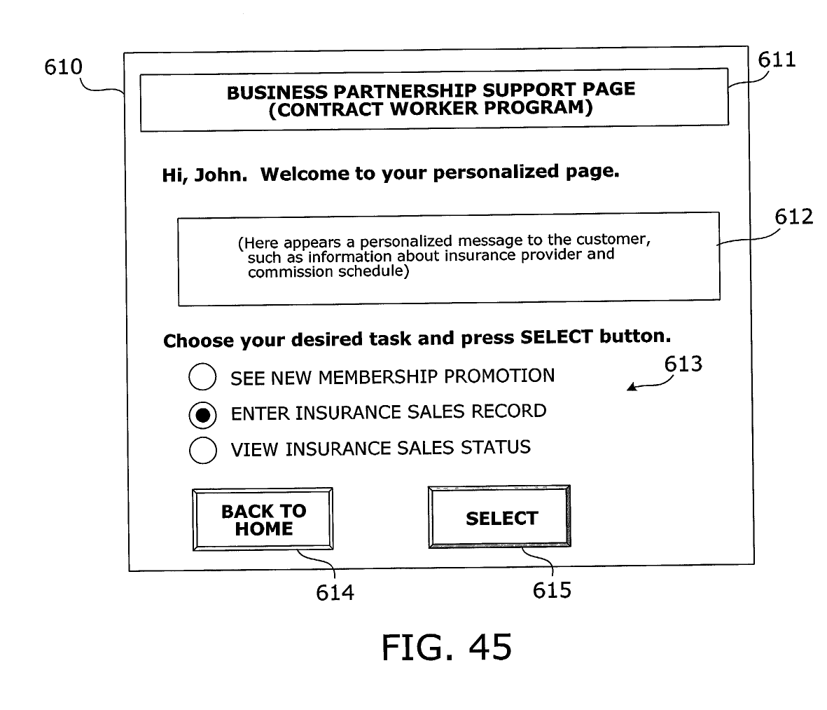

FIG. 45 shows an example of a contract worker menu page. This contract worker menu page 610 has a title bar 611, a personalized message field 612, a menu selection area 613, a HOME button 614, and a SELECT button 615. The title bar 611 shows the subject of the contract worker menu page 610, which is “Business Partnership Support Page (Contract Worker Program)” in the example of FIG. 45. The contract worker who is visiting this page finds a message from the system in the personalized message field 612, which is about the commission schedule, for example.

The menu selection area 613 provides a list of tasks for the contract worker to select. In the example of FIG. 45, they include the following items: “See New Membership Promotion,” “Enter Insurance Sales Record,” and “View Insurance Sales Status.” Each item listed in the menu selection area 613 has a check box to allow the customer to select his/her desired task by placing a checkmark.

The HOME button 614 is used to return to the homepage 200 without selecting any task. The service delivery support system 100 sends the data of homepage 200 to the terminal 40 when the HOME button 614 is pressed. The SELECT button 615 takes the customer to the next page for performing the selected task. When this SELECT button 615 is pressed, the terminal 40 sends the current selection in the menu selection area 613 to the service delivery support system 100. This causes the terminal 40 to display an insurance sales record entry page 620.

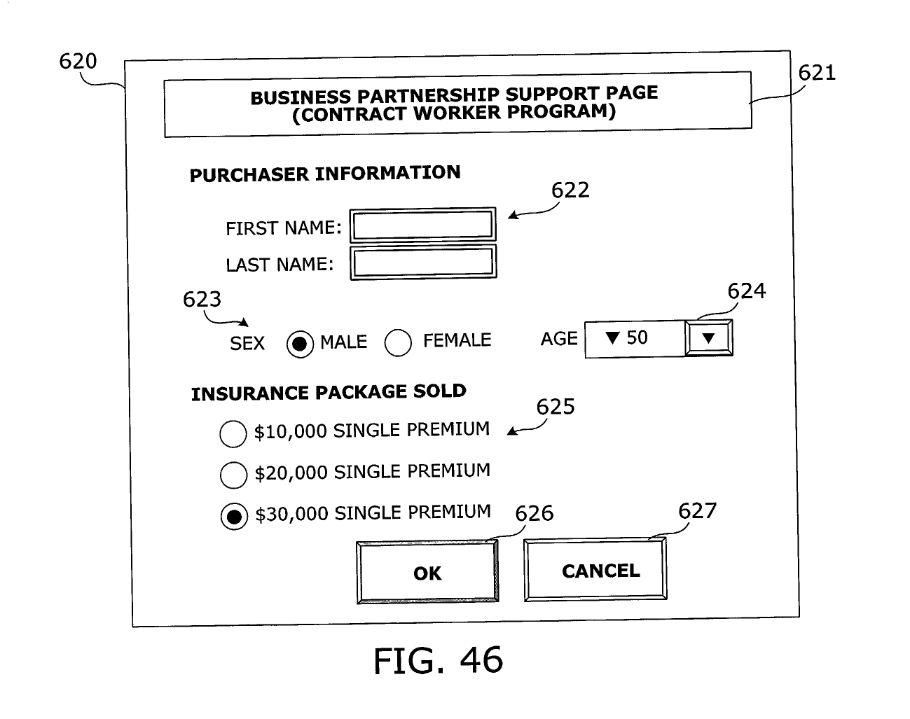

FIG. 46 shows an example of the insurance sales record entry page 620, which has the following components: a title bar 621, a name entry area 622, check boxes 623 (SEX), a list box 624 (AGE), an insurance package selection area 625, an OK button 626, and a CANCEL button 627. The insurance package selection area 625 provides a list of insurance products that the contract worker is selling. The list may be customized on the basis of which insurance company he/she is working for and what insurance product line that company has. More specifically, the service delivery support system 100 automatically compiles an optimized menu, consulting its local databases related to the contract worker program. This customization capability eliminates the need for contract workers to specify an appropriate insurance company each time they enter a new sales record.

The title bar 621 shows the subject of the insurance sales record entry page 620, which is “Business Partnership Support Page (Contract Worker Program)” in the example of FIG. 46. The contract worker enters some pieces of personal information of an insurance purchaser who is willing to accept his/her sales offer. The first and last names of the purchaser are entered into the name entry area 622. The purchaser's gender is specified by selecting either one of the two check boxes 623. The list box 624 is used to enter the age of the purchaser, using a drop-down list for selecting a particular age from predefined definitions.

The OK button 626 enables the contract worker to request the service delivery support system 100 to process the new insurance contract described in the insurance sales record entry page 620. That is, the data items entered in the insurance sales record entry page 620 is transferred to the service delivery support system 100 when the OK button 626 is pressed. The contract worker may want to press the CANCEL button 627 to leave the page without registering the data for any reason. The CANCEL button 627 takes him/her back to, for example, the homepage 200.

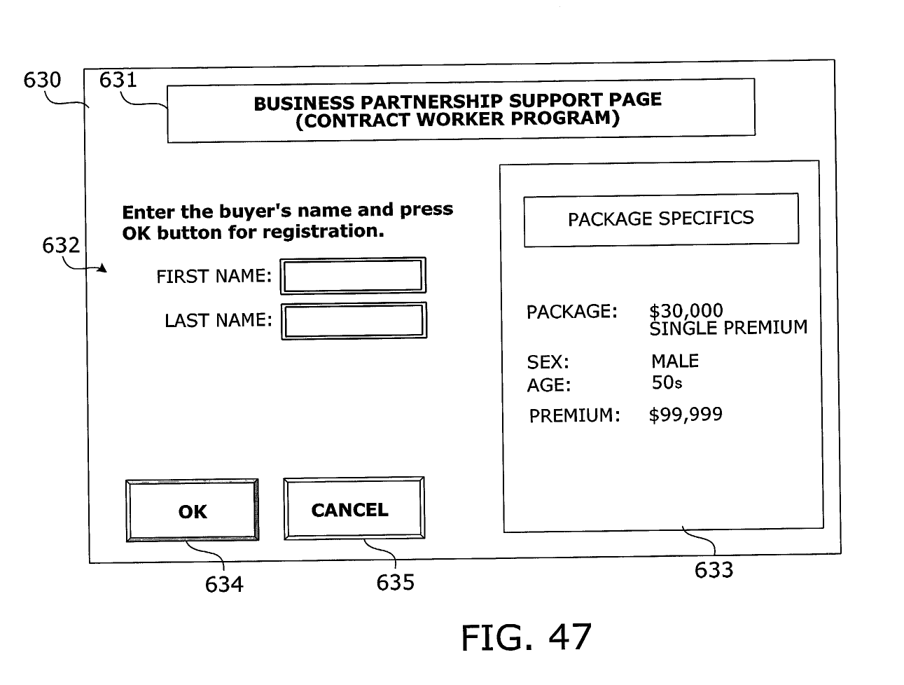

Suppose here that the OK button 626 has been pressed in the above-described insurance sales record entry page 620. This operation causes an insurance sales record confirmation page 630 to appear on the screen of the terminal 40. FIG. 47 shows an example of this insurance sales record confirmation page 630, which has a title bar 631, a name entry area 632, a contract summary area 633, an OK button 634, and a CANCEL button 635.

The title bar 631 shows the subject of the insurance sales record confirmation page 630. which is “Business Partnership Support Page (Contract Worker Program)” in the example of FIG. 47. The name area 632 is used to enter the name of the purchaser. The insurance contract is displayed in the contract summary area 633. The customer presses the OK button 634 when he/she finds no problems with the displayed contract details. The depression of the OK button 634 causes the terminal 40 to inform the service delivery support system 100 of the confirmation of the insurance sales record. The CANCEL button 635, on the other hand, allows the customer to cancel the registration of the record, taking him/her back to an upper-layer page, such as the insurance sales record entry page 620.

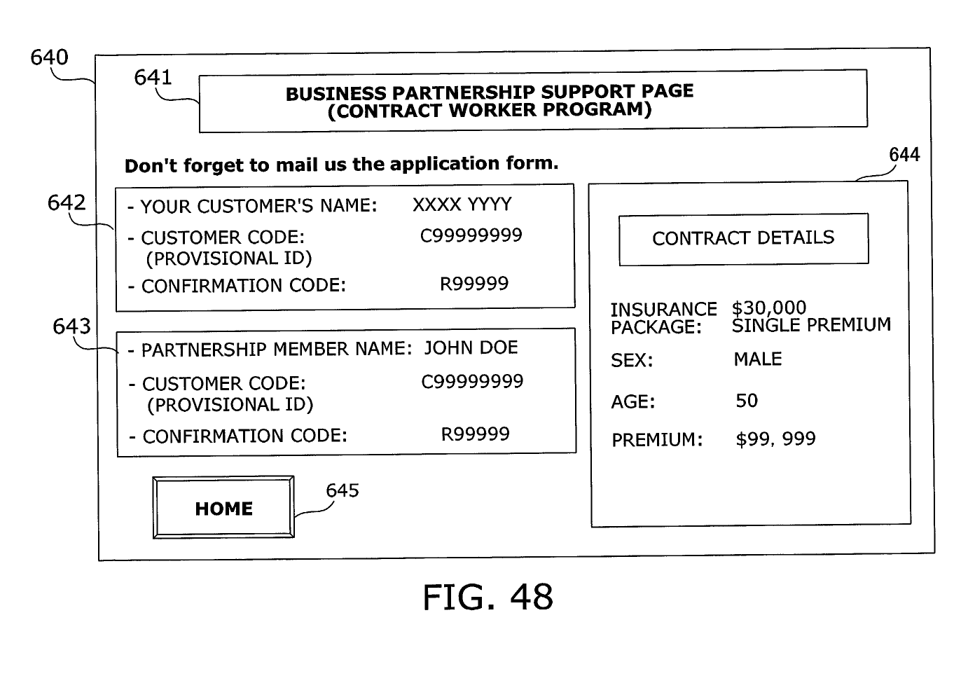

Suppose here that the OK button 634 has been pressed in the above-described insurance sales record confirmation page 630. This operation causes an insurance sales acknowledgment page 640 to appear on the screen of the terminal 40. FIG. 48 shows an example of this insurance sales acknowledgment page 640, which has a title bar 641, a customer data viewing area 642, a contract worker profile field 643, a contract summary area 644, and a HOME button 645.

The title bar 641 shows the subject of the insurance sales acknowledgment page 640, which is “Business Partnership Support Page (Contract Worker Program)” in the example of FIG. 48. The customer data viewing area 642 summarizes the information about the insurance purchaser. The contract worker profile field 643 displays the profile of the contract worker who solicited the customer. The contract summary area 644 shows specifics of the sold insurance contract. After confirming the items on the insurance sales acknowledgment page 640, the customer presses the HOME button 645, thus concluding the sales record entry process. The service delivery support system 100 sends the data of homepage 200 to the terminal 40 when the HOME button 614 is pressed.

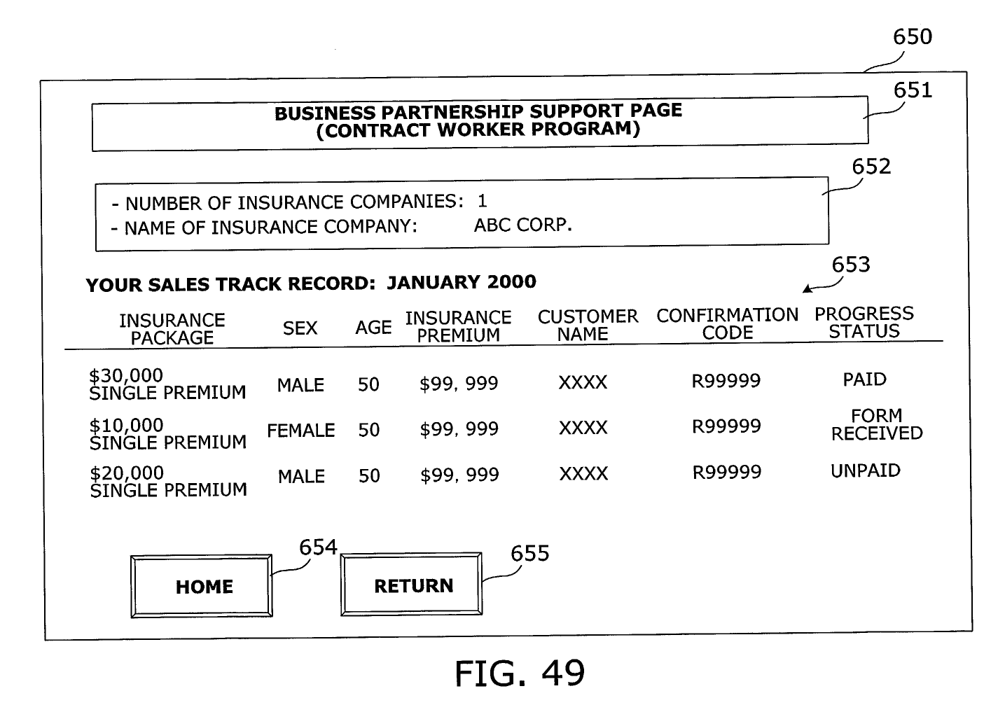

Still another page relating to the process of registering a new insurance contract is an insurance sales status page 650, which appears when the customer chooses the third menu item “View Insurance Sales Status” in the contract worker menu page 610 of FIG. 45. FIG. 49 shows an example of this insurance sales status page 650. The insurance sales status page 650 has a title bar 651, an insurance provider information field 652, a sales track record viewing field 653, a HOME button 654, and a RETURN button 655.

The title bar 651 shows the subject of the insurance sales status page 650, which is “Business Partnership Support Page (Contract Worker Program)” in the example of FIG. 49. The insurance provider information field 652 shows the name of an insurance company for which the requesting contract worker is working as a sales agent.

The sales track record viewing field 653 displays a list of insurance contracts made through the mediation of the contract worker. In the example of FIG. 49, each entry of list carries the following information: the name of an insurance package sold, sex and age of the purchaser, insurance premium that the purchaser should pay, purchaser's name, confirmation code, and progress status of the contract. The last data field “progress status” indicates the current state of the registered contract. FIG. 49 shows a few examples of this field. The state “Paid” means that the purchaser has paid up the lump-sum insurance premium, while the state “Unpaid” refers to the opposite situation. The state “Form Received” means that the service site operating company has received the signed contract form from the insurance purchaser.

After viewing the items on such an insurance sales status page 650, the customer presses the HOME button 654, This operation takes him/her back to the homepage 200. The RETURN button 655, on the other hand, allows the customer to return to the upper-layer page of the insurance sales status page 650. When this button 655 is pressed, the contract worker menu page 610, for example, appears on the screen of the terminal 40.

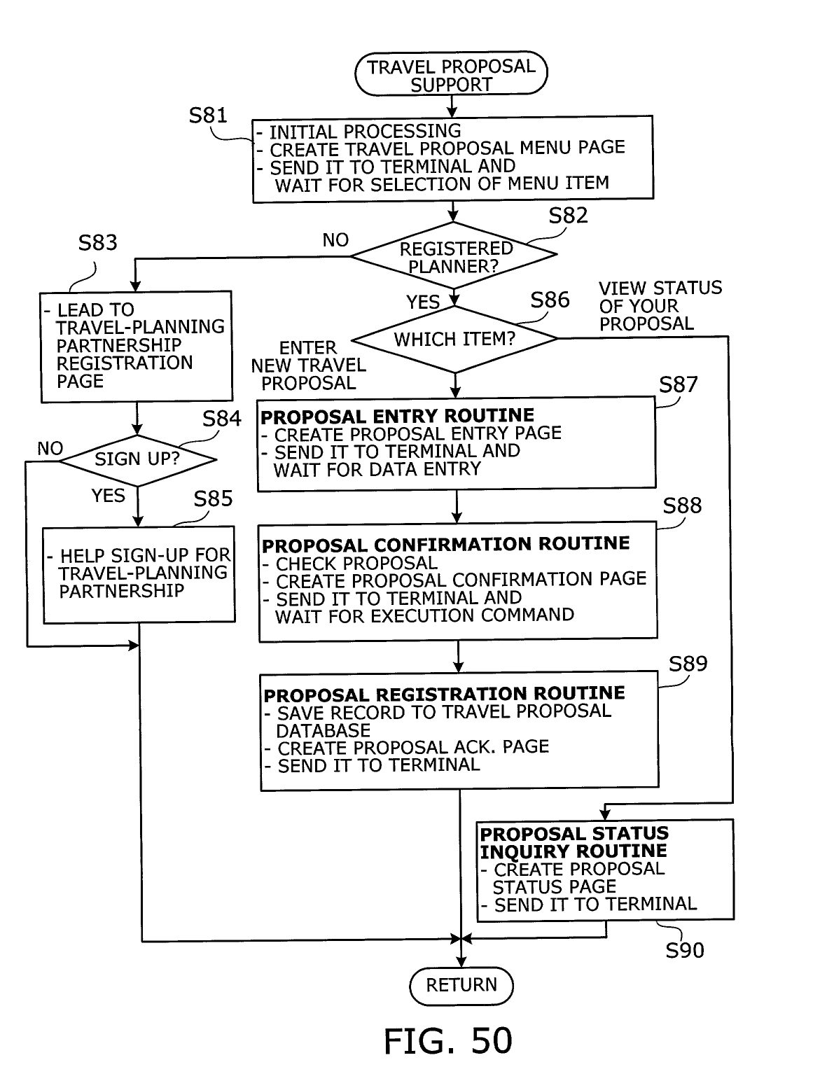

Referring next to FIGS. 50 to 55, the following section will discuss the travel proposal support routine. FIG. 50 is a flowchart of the travel proposal support routine, which comprises the following steps.

(S81) The travel proposal processor 115 starts with initial processing. It then creates a travel proposal menu page, and sends the page to the terminal 40. After that the travel proposal processor 115 enters to an idle state, waiting for the customer to select a menu item.

(S82) Upon receipt of the information about the customer's selection, the travel proposal processor 115 then determines whether the customer is a registered member of the travel planning partnership program. If so, the process advances to step S86. If not, the process proceeds to step S83.

(S83) Now that the customer has turned out to be a non-member, the travel proposal processor 115 leads him/her to another page which provides the information about the travel-planning partnership program. The customer may wish to participate in the program.

(S84) Based on the customer's reaction at step S83, the travel proposal processor 115 determines whether the customer wishes to sign up for the travel planning partnership program. If so, the process advances to step S85. If not, the travel proposal processor 115 exits from the travel proposal support routine. Accordingly, the process resumes from step S15 shown in the flowchart of FIG. 18.

(S85) The travel proposal processor 115 helps the customer sign up for the travel planning partnership program. It then exits from the travel proposal support routine, allowing the process to resume from step S15 shown in the flowchart of FIG. 18.

(S86) Since the customer has turned out to be a registered member, the travel proposal processor 115 then determines which menu item is selected in the travel proposal menu page. If the selection is “Enter New Travel Proposal,” the process advances to step S87. If it is “View Travel Proposal Status,” then the process branches to step S90.

(S87) The travel proposal processor 115 executes a travel proposal entry routine. More specifically, the travel proposal processor 115 creates a travel proposal entry page and sends the page to the terminal 40. After that the travel proposal processor 115 enters to an idle state, waiting for a travel proposal to be sent from the terminal 40.

(S88) Upon receipt of a travel proposal, the travel proposal processor 115 executes a travel proposal confirmation routine. More specifically, the travel proposal processor 115 checks the consistency of the received proposal, creates a travel proposal confirmation page, and sends it to the terminal 40. After that, it enters to an idle state, waiting for the customer to permit the registration.

(S89) Upon receipt of a registration execution command from the terminal 40, the travel proposal processor 115 executes a travel proposal registration routine. More specifically, the travel proposal processor 115 first registers the received travel proposal to the travel proposal database 160. It then creates an insurance sales acknowledgment page for delivery to the terminal 40. After that, the travel proposal processor 115 exits from the travel proposal support routine, allowing the process to resume from step S15 shown in the flowchart of FIG. 18.

(S90) The travel proposal processor 115 executes a travel proposal status inquiry routine. More specifically, the travel proposal processor 115 creates a travel proposal status page and sends it to the terminal 40. After that, the travel proposal processor 115 exits from the travel proposal support routine, allowing the process to resume from step S15 shown in the flowchart of FIG. 18.

The above steps constitute the travel proposal support routine. Customers enjoy such support services by simply following instructions in the pages sent from the service delivery support system 100 to their terminals 40. The next section will focus on such pages used in the travel proposal support services.

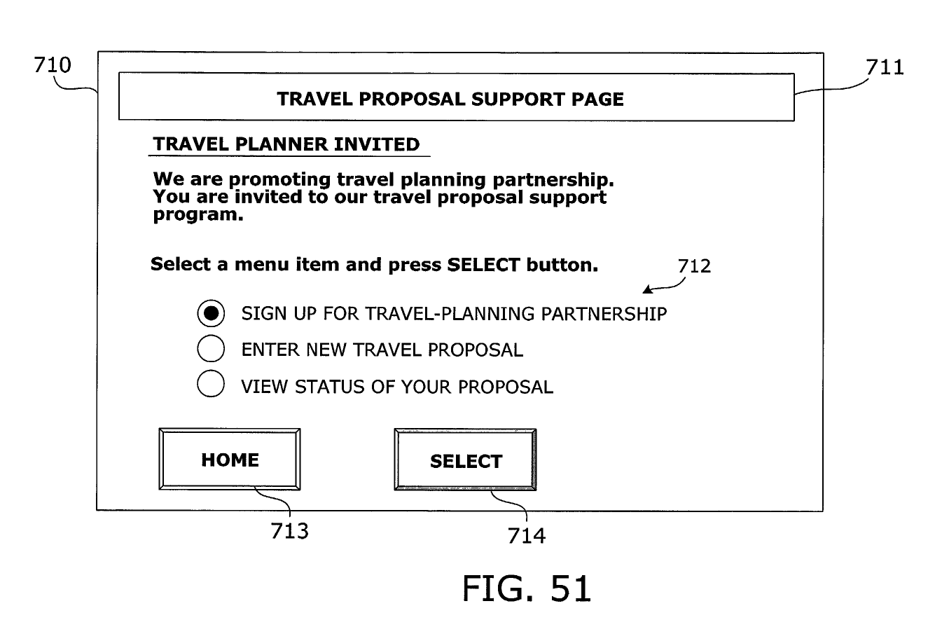

FIG. 51 shows an example of a planner invitation page. This planner invitation page 710 has a title bar 711, a menu selection area 712, a HOME button 713, and a SELECT button 714. The title bar 711 shows the subject of the planner invitation page 710, which is “Travel Proposal Support Page” in the example of FIG. 51. The menu selection area 712 provides a menu of support services about travel proposals. In the example of FIG. 51, the menu items include: “Sign Up for Travel-Planning Partnership,” “Enter New Travel Proposal,” “View Travel Proposal Status.” Each menu item has a check box, allowing the customer to select a desired item by clicking a corresponding check box.

The HOME button 713 is used to leave the page 710 without using any travel proposal support service. The homepage 200 appears on the screen of the terminal 40 when the HOME button 713 is pressed. The SELECT button 714, on the other hand, is used to receive a particular service. When this SELECT button 714 is pressed, the terminal 40 requests the service delivery support system 100 to provide a service that has been selected in the menu selection area 712.

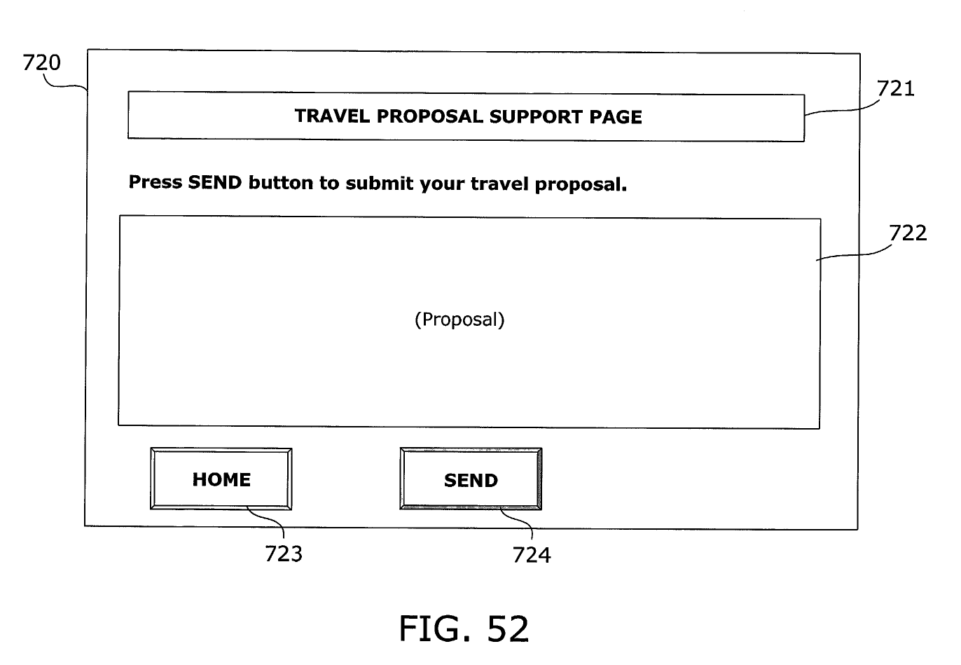

Suppose here that the customer has chosen the second menu item “Enter New Travel Proposal” and pressed the SELECT button 714. This operation causes a proposal entry page 720 to appear on the screen of the terminal 40. FIG. 52 shows an example of this travel proposal entry page 720, which has a title bar 721, a proposal entry area 722, a HOME button 723, and a SEND button 724.

The title bar 721 shows the subject of the proposal entry page 720, which is “Travel Proposal Support Page” in the example of FIG. 52. The proposal entry area 722 is prepared for the customer to enter his/her travel plan in a prescribed format.

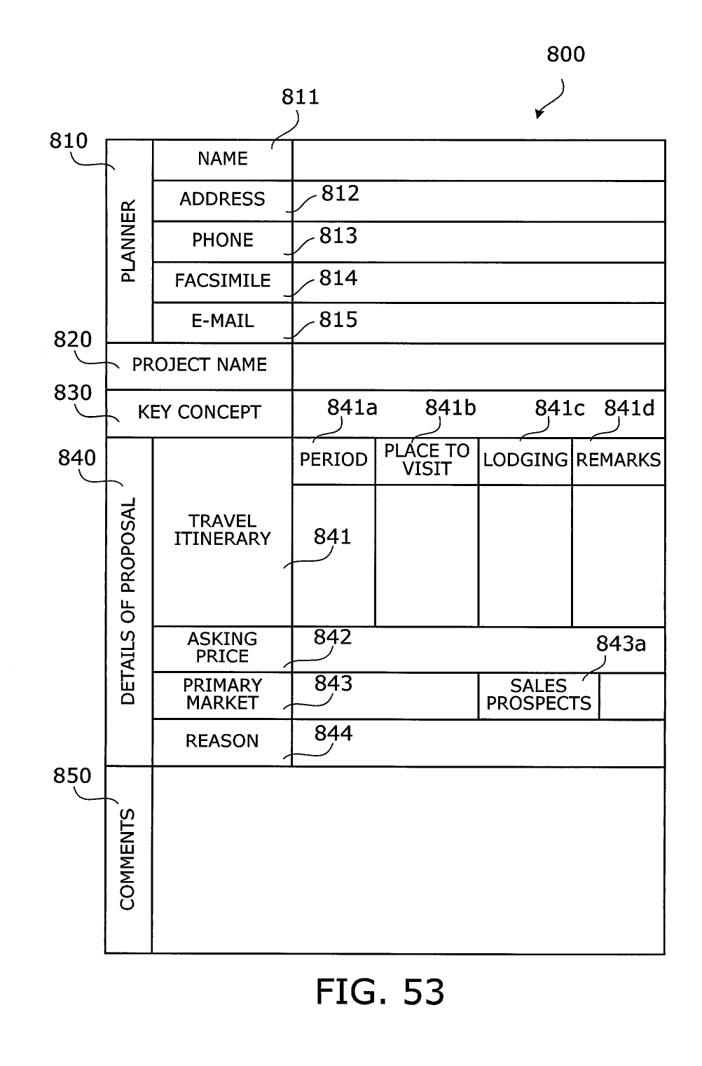

The HOME button 723 is used to quit sending the travel proposal, bringing the screen of the terminal 40 back to the homepage 200. The SEND button 724, on the other hand, is used to submit the travel proposal. When this SEND button 724 is pressed, the terminal 40 transmits the travel proposal in the proposal entry area 722 to the service delivery support system 100. FIG. 53 shows an example of a travel proposal form. This travel proposal form 800 is displayed in the proposal entry area 722 on the proposal entry page 720. The customer develops a travel plan by filling out the data fields of this form 800, which are roughly divided into five groups as follows: a planner information block 810, a project name block 820, a key concept block 830, a project description block 840, and a comment block 850.

The planner information block 810 shows the personal information of the planner, i.e., the customer proposing a travel plan. The planner information block 810 consists of the following data fields: a name field 811, an address field 812, a phone number field 813, a facsimile number field 814, and an e-mail address field 815.

The project name block 820 contains the title of the travel proposal, something like “Autumn Tour—Gourmet's Delight.” The key concept block 830 is used to explain the policy of the proposal. The specifics of the proposed travel should be presented in the project description area 840, which consists of the following fields: a travel itinerary field 841, an asking price field 842, a sales market field 843, and a motivation field 844.

The planned route will be described in the travel itinerary field 841, which include: a period field 841a for entering a proposed period of tours (e.g., September to November), a place-to-visit field 841b for describing where to go (e.g., Florida), a lodging field 841c for describing where to stay, and a remarks field 841d for adding particular notes. The asking price field 842 shows what the planner thinks is a competitive price. The sales market field 843 shows what the planner thinks is a target sector for marketing (e.g., retired people). The sales market field 843 has a subfield 843a to enter the number of prospect buyers. The motivation field 844 describes what made the planner to submit this proposal. The comment field 850 is used to enter any messages from the planner to the service site operating company.

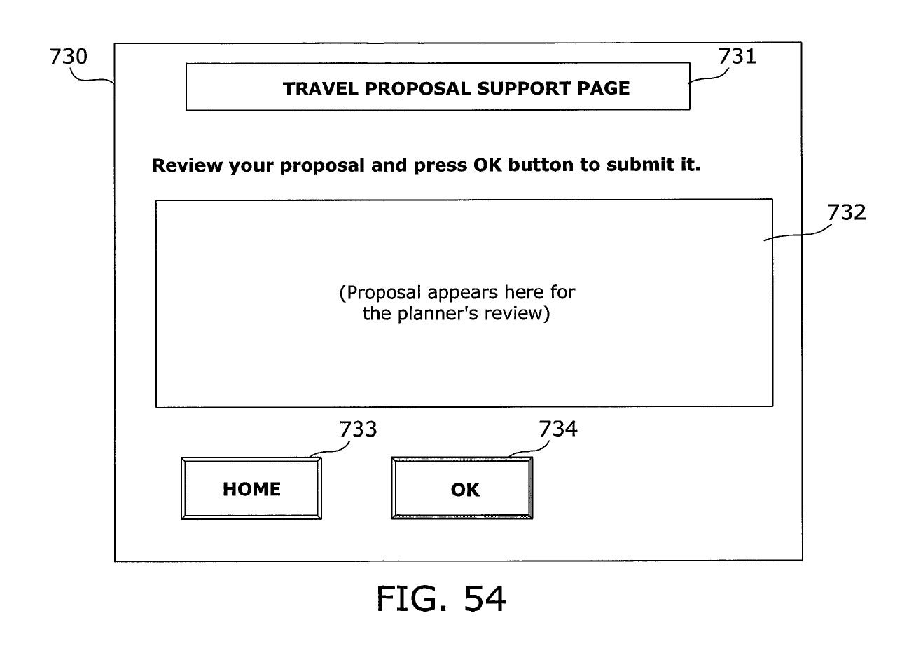

By filling out the above items on the proposal entry page 720, the planner develops a travel proposal. He/she then presses the SEND button 724, causing a proposal confirmation page 730 to appear on the screen of his/her terminal 40. FIG. 54 shows an example of this travel proposal confirmation page 730, which has a title bar 731, a proposal viewing area 732, a HOME button 733, and an OK button 734.

The title bar 731 shows the subject of the proposal confirmation page 730, which is “Travel Proposal Support Page” in the example of FIG. 54. The planner's proposed travel plan is shown in the proposal viewing area 732.

The HOME button 733 is used to leave the page 730 without registering the proposal, bringing the screen of the terminal 40 back to the homepage 200. The OK button 734, on the other hand, is used to confirm the travel proposal. When this OK button 734 is pressed, the terminal 40 transmits requests the service delivery support system 100 to register the proposal shown in the proposal viewing area 732.

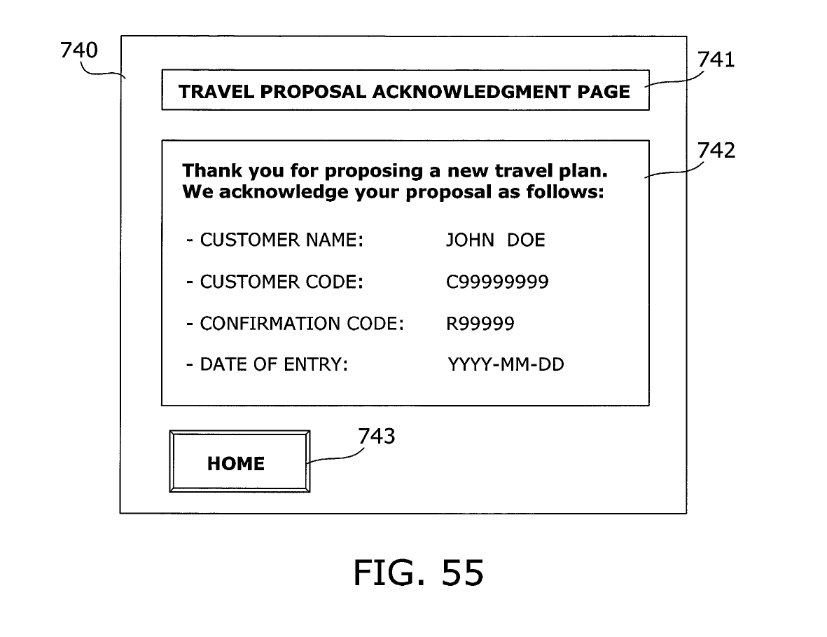

The depression of the OK button 734 takes the planner to a proposal acknowledgment page 740. FIG. 55 shows an example of this travel proposal acknowledgment page 740, which has a title bar 741, a proposal entry viewing area 742, and a HOME button 743.

The title bar 741 shows the subject of the proposal acknowledgment page 740, which is “Travel Proposal Acknowledgment Page” in the example of FIG. 55. The proposal entry viewing area 742 acknowledges the reception of the travel proposal. In the example of FIG. 55, it gives the following information: the name and code of the customer who has submit a travel proposal, the confirmation code of the proposal, and the date of data entry. After confirming the content of the proposal acknowledgment page 740, the customer presses the HOME button 743 to go back to the homepage 200.

The above process permits a registered member to propose a new travel plan. The travel proposal is reviewed by the service site operating company, and if they think the proposed package worth promoting, it is then registered to the service delivery support system 100 for marketing. If that travel package is sold, a predetermined fee is paid to the planner. In this way, the members of travel planning partnership earn some money from travel package products that they have produced on the basis of their experiences. This feature is also beneficial to the service site operating company, since they can develop new attractive service plans by collecting proposals from their experienced members.

The above processing functions of the present invention are realized on a client and server environment. The functions of the service delivery support system are implemented as server programs, while those of the terminal are provided as client programs. The proposed service delivery support system is realized by executing the server programs on an appropriate server computer. Likewise, the proposed terminal is realized by executing the client programs on an appropriate client computer.

The above server and client programs are stored in a computer-readable medium for the purpose of storage and distribution. Suitable computer-readable storage media include magnetic storage media, optical discs, magneto-optical storage media, and solid state memory devices. Magnetic storage media include hard disk drives (HDD), floppy disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the circulation of the server and client programs. Network-based distribution of software programs is also possible, in which the client program files stored in a server computer are downloaded to client computers via the network.

The server computer stores server programs in its local storage unit, which have been previously installed from a portable storage media. The server computer executes the server programs read out of the local storage unit, thereby providing its intended functions. Alternatively, the server computer may execute those programs directly from the portable storage media.

The client computer, on the other hand, stores client programs in its local storage unit, which have been previously installed from a portable storage media or downloaded from the server computer. The client computer provides its intended functions by executing the client programs read out of the local storage unit. As an alternative way of program execution, the client computer may execute the client programs directly from the portable storage media. Another alternative method is that the server computer supplies the client computer with client programs dynamically, allowing the client computer to execute them upon delivery.

As seen from the above description of the present invention, the proposed service delivery support system helps customers use paid services by paying service fees on behalf of the customers. It is therefore possible for the customers to enjoy such services even when they have enough cash on hand. That is, the present invention improves the accessibility to paid services. While free services are inherently limited in their variety, a wide range of paid services contribute to improving people's standard of living.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method executed by a computer to support service site operations for offering paid services to customers, comprising the steps of:
providing, via a network, information about paid services to a customer who has signed up for membership with payment of a predetermined fee;
at a terminal of the customer which is connected to the computer via the network, receiving an order for one of the paid services;
evaluating creditworthiness of the customer, based on the amount of the predetermined fee that has been paid by the customer;
determining how much on-behalf payment can be offered to the customer in payment for the paid service that the customer has ordered; and
notifying the terminal of the determined amount of the on-behalf payment.

2. The method according to claim 1, further comprising the step of paying, on behalf of the customer, the determined amount of money to a provider of the paid service that has been ordered.

3. The method according to claim 1, wherein the customer is a purchaser of an insurance product.

4. The method according to claim 1, wherein the paid services include travel packages.

5. The method according to claim 1, wherein the paid services include license acquisition courses.

6. The method according to claim 1, further comprising the steps of:
making the customer promote sales of products to other members; and
paying a commission to the customer when the customer receives an order for one of the products.

7. The method according to claim 6, wherein said step of making the customer promote the sales is executed only if the customer has a sales agent license for a predetermined set of insurance products.

8. The method according to claim 7, further comprising the steps of:
compiling an information entry page which is customized according to the sales agent license that the customer owns; and
sending data of the customized information entry page to the terminal.

9. The method according to claim 1, further comprising the steps of:
receiving from the customer a proposal for a travel product; and
providing other members with information about the proposed travel product as one of the paid services.

10. The method according to claim 9, further comprising the step of paying a commission to the customer who has proposed the travel product.

11. A method of ordering a service from a terminal to a service delivery support system, comprising the steps of:
displaying information about paid services obtained from the service delivery support system on a screen of the terminal;
sending a purchase order for one of the paid services to the service delivery support system in response to an input from a customer;
receiving information about on-behalf payment to be offered to the customer from the service delivery support system; and
displaying the amount of the on-behalf payment on the terminal.

12. A service delivery support system for supporting provision of paid services, comprising:
information providing means for providing, via a network, information about paid services to a customer who has signed up for membership with payment of a predetermined fee;
reception means for receiving an order for one of the paid services from a terminal of the customer which is connected to the service delivery support system via the network;
on-behalf payment determining means for evaluating creditworthiness of the customer, based on the amount of the predetermined fee that has been paid by the customer, and determining how much on-behalf payment can be offered to the customer in payment for the paid service that the customer has ordered; and
notification means for notifying the terminal of the determined amount of the on-behalf payment.

13. The service delivery support system according to claim 12, wherein the customer is a purchaser of an insurance product.

14. The service delivery support system according to claim 12, wherein the paid services include travel packages.

15. The service delivery support system according to claim 12 wherein the paid services include license acquisition courses.

16. The service delivery support system according to claim 12, further comprising proposal reception means for receiving a travel proposal from the customer,
wherein said information providing means informs another customer of the received travel proposal as one of the paid services.

17. A terminal which sends a purchase order to a service delivery support system which assists delivery of paid services, comprising:
information displaying means for displaying information about paid services which is supplied from the service delivery support system;
order sending means for sending a purchase order for one of the paid services to the service delivery support system in response to an input from a customer; and
on-behalf payment information displaying means for receiving information about on-behalf payment to be offered to the customer from the service delivery support system, and displaying the amount of the on-behalf payment on the terminal.

18. A program product, for use with a computer system, for assisting delivery of paid services, said program product causing the computer system to perform the steps of:
providing, via a network, information about paid services to a customer who has signed up for membership with payment of a predetermined fee;
receiving an order for one of the paid services from a terminal of the customer which is connected to the computer system via the network;
evaluating creditworthiness of the customer, based on the amount of the predetermined fee that has been paid by the customer;
determining how much on-behalf payment can be offered to the customer in payment for the paid service that the customer has ordered; and
notifying the terminal of the determined amount of the on-behalf payment.

19. A program product, for use with a computer system, for sending a purchase order to a service delivery support system which assists delivery of paid services, said program product causing a computer system to perform the steps of:
displaying information about the paid services which is supplied from the service delivery support system;
sending a purchase order for one of the paid services to the service delivery support system in response to an input from a customer;
receiving information about on-behalf payment to be offered to the customer from the service delivery support system; and
displaying the amount of the on-behalf payment on the terminal.

20. A computer-readable storage medium storing a service delivery supporting program which assists delivery of paid services with a computer system, the service delivery supporting program causing the computer system to perform the steps of:
providing, via a network, information about paid services to a customer who has signed up for membership with payment of a predetermined fee;
receiving an order for one of the paid services from a terminal of the customer which is connected to the computer system via the network;
evaluating creditworthiness of the customer, based on the amount of the predetermined fee that has been paid by the customer;
determining how much on-behalf payment can be offered to the customer in payment for the paid service that the customer has ordered; and
notifying the terminal of the determined amount of the on-behalf payment.

21. A computer-readable storage medium storing a paid-service ordering program which sends a purchase order to a service delivery support system designed to assist delivery of paid services, the paid-service ordering program causing a computer system to perform the steps of:
displaying information about the paid services which is supplied from the service delivery support system;
sending a purchase order for one of the paid services to the service delivery support system in response to an input from a customer;
receiving information about on-behalf payment to be offered to the customer from the service delivery support system; and
displaying the amount of the on-behalf payment on the terminal.
